(19) United States
(12) Patent Application Publication
(10) Pub. No.: US 2013/0053493 A1
(43) Pub. Date: Feb. 28, 2013

(54) METHOD FOR PRODUCING FLUORINATED COPOLYMER COMPOSITION, COATING COMPOSITION, ARTICLE HAVING COATING FILM, AND MOLDED PRODUCT

(71) Applicants: Takashi Nakano, Tokyo (JP); Kuniko Okano, Tokyo (JP)

(72) Inventors: Takashi Nakano, Tokyo (JP); Kuniko Okano, Tokyo (JP)

(73) Assignee: Asahi Glass Company, Limited, Tokyo (JP)

(21) Appl. No.: 13/613,014

(22) Filed: Sep. 13, 2012

Related U.S. Application Data
(63) Continuation of application No. PCT/JP2011/059301, filed on Apr. 14, 2011.

(30) Foreign Application Priority Data
Apr. 16, 2010 (JP) 2010-094981

(51) Int. Cl. C09D 127/18; C08K 5/101; C08K 5/07

(52) U.S. Cl. 524/315; 524/520; 524/365; 524/360; 524/359

(57) ABSTRACT

This invention relates to a method for producing a fluorinated copolymer composition, capable of uniformly mixing a fluorinated copolymer (A) having repeating units derived from ethylene and repeating units derived from tetrafluoroethylene, and a thermoplastic resin (B), at a relatively low temperature. The invention also relates to a method for producing a fluorinated copolymer composition comprising a fluorinated copolymer (A), a thermoplastic resin (B) which excludes the fluorinated copolymer (A), and a medium (C) capable of dissolving at least the fluorinated copolymer (A). The invention also relates to a coating composition capable of forming a coating film provided with characteristics of the fluorinated copolymer (A) and the thermoplastic resin (B), an article having such a coating film, and a molded product.

### TECHNICAL FIELD

The present invention relates to a method for producing a fluorinated copolymer composition, a coating composition comprising a fluorinated copolymer composition obtained by such a method, an article having a coating film formed by using such a coating composition, and a molded product obtained by using the fluorinated copolymer composition.

### BACKGROUND ART

Fluororesins are excellent in solvent resistance, low dielectric constant, low surface energy, non-tackiness, weather resistance, etc. and therefore are used for various applications for which common plastics may not be useful. Among such fluororesins, a fluorinated copolymer (hereinafter referred to also as ETFE) having repeating units derived from ethylene and repeating units derived from tetrafluoroethylene is excellent in heat resistance, flame retardancy, chemical resistance, weather resistance, low frictional properties, low dielectric constant properties, transparency, etc. and therefore is used in a wide range of fields including covering material for heat resistant wires, corrosion resistant piping for chemical plants, material for plastic greenhouses for agriculture, mold release films, etc.

However, ETFE may sometimes be inadequate in mechanical strength, dimensional stability or moldability, and it is also expensive. Therefore, in order to make up for demerits of ETFE while utilizing its merits to the maximum extent, studies have been made, for example, to bond, laminate or complex it with other resins (e.g. Patent Documents 1 and 2).

However, ETFE has a low surface free energy, and its adhesive strength with other resins is inadequate, whereby it is hardly bonded to other resins. Further, its miscibility with other resins is poor, and even if it is mixed with other resins by melt-kneading, it is difficult to uniformly mix or homogenize them. Further, in the case of melt kneading, the mixture is exposed to a high temperature, whereby the properties of ETFE and other resins are likely to deteriorate.

### PRIOR ART DOCUMENTS

### Patent Documents

Patent Document 1: JP-A-11-189947

Patent Document 2: JP-A-2002-322334

### DISCLOSURE OF INVENTION

### Technical Problem

It is an object of the present invention to provide a method for producing a fluorinated copolymer composition, capable of uniformly mixing a fluorinated copolymer having repeating units derived from ethylene and repeating units derived from tetrafluoroethylene, and another thermoplastic resin, at a relatively low temperature; a coating composition capable of forming a coating film provided with characteristics of the fluorinated copolymer and another resin; an article having a coating film provided with characteristics of the fluorinated copolymer and another resin; and a molded product provided with characteristics of the fluorinated copolymer and another resin.

### Solution to Problem

The method for producing a fluorinated copolymer composition of the present invention is a method for producing a fluorinated copolymer composition comprising a fluorinated copolymer (A) having repeating units derived from ethylene and repeating units derived from tetrafluoroethylene, a thermoplastic resin (B) (provided that the fluorinated copolymer (A) is excluded) and a medium (C) capable of dissolving at least the fluorinated copolymer (A), which comprises mixing the fluorinated copolymer (A) and the thermoplastic resin (B) in the medium (C) at a temperature of at least the dissolution temperature at which the fluorinated copolymer (A) dissolves in the medium (C) and not higher than the melting point of the fluorinated copolymer (A).

As the above medium (C), it is preferred to employ a solvent, of which the dissolution index (R) represented by the following formula (1) is less than 49:

R=4×(δd−15.7)²+(δp−5.7)²+(δh−4.3)² (1)

wherein δd, δp and δh represent the dispersion component, the polar component and the hydrogen bonding component [(MPa)^{1/2}], respectively, in Hansen solubility parameters of the solvent.

In the fluorinated copolymer (A), the proportion of repeating units derived from monomers other than ethylene and tetrafluoroethylene, is preferably from 0.1 to 50 mol %, based on all repeating units (100 mol %).

As the above medium (C), it is preferred to use a solvent, with which a temperature range to exhibit a solution state with the fluorinated copolymer (A) is present at a temperature of not higher than 230° C.

The mass ratio of the fluorinated copolymer (A) to the thermoplastic resin (B) (i.e. (A)/(B)) is preferably from 99/1 to 1/99.

The proportion of the medium (C) is preferably from 10 to 99 mass % based on 100 mass % of the fluorinated copolymer composition.

The above medium (C) is preferably diisopropyl ketone, 2-hexanone, cyclohexanone, 3′,5′-bis(trifluoromethyl)acetophenone, 2′,3′,4′,5′,6′-pentafluoroacetophenone, benzotrifluoride, or isobutyl acetate.

The coating composition of the present invention is characterized in that it comprises a fluorinated copolymer composition obtained by the method of the present invention.

The article having a coating film of the present invention is characterized in that it has a coating film formed by using the coating composition of the present invention.

The molded product of the present invention is characterized in that it is a molded product comprising the fluorinated copolymer (A) and the thermoplastic resin (B), obtained by using a fluorinated copolymer composition obtained by the method of the present invention.

### Advantageous Effects of Invention

According to the method for producing a fluorinated copolymer composition of the present invention, it is possible to uniformly mix a fluorinated copolymer having repeating units derived from ethylene and repeating units derived from tetrafluoroethylene, and another thermoplastic resin, at a relatively low temperature.

According to the coating composition of the present invention, it is possible to form a coating film provided with characteristics of the fluorinated copolymer and another thermoplastic resin.

The article having a coating film of the present invention, has a coating film provided with characteristics of the fluorinated copolymer and another thermoplastic resin.

The molded product of the present invention is provided with characteristics of the fluorinated copolymer and another thermoplastic resin.

### DESCRIPTION OF EMBODIMENTS

In this specification, “repeating units” means units derived from a monomer formed by polymerization of such a monomer. The repeating units may be units formed directly by a polymerization reaction, or units having some of such units converted to another structure by treating the polymer.

Further, in this specification, a “monomer” means a compound having a polymerization-reactive carbon-carbon double bond.

Further, in this specification, a “solution state” having the fluorinated copolymer (A) and/or the thermoplastic resin (B) dissolved in the medium (C) means a uniform state having no insolubles observed by visual determination after thoroughly mixing a mixture of the fluorinated copolymer (A) and/or the thermoplastic resin (B), and the medium (C).

Further, in this specification, a “dissolution temperature” is a temperature measured by the following method.

0.10 g in total of the fluorinated copolymer (A) and/or the thermoplastic resin (B) is added to 4.95 g of the medium (C), followed by heating while maintaining a sufficiently mixed state constantly by e.g. a stirring means, whereby whether or not the fluorinated copolymer (A) and/or the thermoplastic resin (B) has dissolved, is visually observed. Firstly, a temperature at which the mixture is observed as completely dissolved in a uniform solution state, is confirmed. Then, the solution is gradually cooled, and a temperature at which the solution becomes turbid, is confirmed, and further, the solution is re-heated, whereby a temperature at which it becomes a uniform solution state again is taken as the dissolution temperature.

### <Method for Producing Fluorinated Copolymer Composition>

The method for producing a fluorinated copolymer composition of the present invention is a method for producing a fluorinated copolymer composition comprising a fluorinated copolymer (A), a thermoplastic resin (B) and a medium (C), which comprises mixing the fluorinated copolymer (A) and the thermoplastic resin (B) in the medium (C).

### (Fluorinated Copolymer (A))

The fluorinated copolymer (A) is a copolymer having repeating units derived from ethylene and repeating units derived from tetrafluoroethylene (hereinafter referred to as TFE).

The molar ratio of the repeating units derived from TFE to the repeating units derived from ethylene (i.e. TFE/ethylene) is preferably from 70/30 to 30/70, more preferably from 65/35 to 40/60, further preferably from 60/40 to 40/60. When the molar ratio is within such a range, the balance will be good between the characteristics attributable to repeating units derived from TFE such as heat resistance, weather resistance, chemical resistance, etc. and the characteristics attributable to repeating units derived from ethylene such as mechanical strength, melt moldability, etc.

It is preferred that the fluorinated copolymer (A) has repeating units derived from monomers other than ethylene and TFE (hereinafter referred to other monomers) in that various functions can be imparted to the obtainable copolymer.

As such other monomers, the following compounds may, for example, be mentioned.

Fluoroethylenes: CF₂═CFCl, CF₂═CH₂, etc. (provided that TFE is excluded)

Fluoropropylenes: CF₂═CFCF₃, CF₂═CHCF₃, CH₂═CHCF₃, etc.

(Polyfluoroalkyl)ethylenes having a C₂₋₁₂ fluoroalkyl group: CF₃CF₂CH═CH₂, CF₃CF₂CF₂CF₂CH═CH₂, CF₃CF₂CF₂CF₂CF═CH₂, CF₂HCF₂CF₂CF═CH₂, etc.

Perfluorovinyl ethers: R^{f} (OCFXCF₂)mOCF═CF₂ (wherein R^{f} is a C₁₋₆ perfluoroalkyl group, X is a fluorine atom or a trifluoromethyl group, and m is an integer of from 0 to 5.)

Perfluorovinyl ethers having a group readily convertible to a carboxylic acid group or a sulfonic acid group: CH₃OC(═O)CF₂CF₂CF₂OCF═CF₂, FSO₂CF₂CF₂OCF(CF₃)CF₂OCF═CF₂, etc.

Olefins: C₃ olefin (such as propylene), C₄ olefin (butylene, isobutylene, etc.), 4-methyl-1-pentene, cyclohexene, styrene, α-methyl styrene, etc. (provided that ethylene is excluded).

Vinyl esters: vinyl acetate, vinyl lactate, vinyl butyrate, vinyl pivalate, vinyl benzoate, etc.

Allyl esters: allyl acetate, etc.

Vinyl ethers: methyl vinyl ether, ethyl vinyl ether, butyl vinyl ether, isobutyl vinyl ether, tert-butyl vinyl ether, cyclohexyl vinyl ether, hydroxybutyl vinyl ether, polyoxyethylene vinyl ether, etc.

(Meth)acrylic acid esters: methyl(meth)acrylate, ethyl(meth)acrylate, n-butyl(meth)acrylate, isobutyl(meth)acrylate, cyclohexyl(meth)acrylate, 4-hydroxybutyl(meth)acrylate, etc.

(Meth)acrylamides: (meth)acrylamide, N-methyl(meth)acrylamide, N-isopropylacrylamide, N,N-dimethyl(meth)acrylamide, etc.

Cyano group-containing monomers: acrylonitrile, etc.

Dienes: isoprene, 1,3-butadiene, etc.

Chloroolefins: vinyl chloride, vinylidene chloride, etc.

Compounds containing a carboxylic anhydride and unsaturated bond: maleic anhydride, itaconic anhydride, citraconic anhydride, etc.

As such other monomers, one type may be used alone, or two or more types may be used in combination.

The proportion of the repeating units derived from other monomers is preferably from 0.1 to 50 mol %, more preferably from 0.1 to 30 mol %, further preferably from 0.1 to 20 mol %, based on all repeating units (100 mol %). When the proportion of the repeating units derived from other monomers is within such a range, it is possible to impart functions such as high solubility, water repellency, oil repellency, adhesion to the substrate, reactivity with the thermoplastic resin (B), etc. without impairing the characteristics of ETFE composed substantially solely of repeating units derived from ethylene and repeating units derived from TFE.

The fluorinated copolymer (A) preferably has functional groups having a reactivity to the thermoplastic resin (B) (hereinafter referred to as reactive functional groups). The reactive functional groups may be present at the molecular terminals, or in a side chain or the main chain of the fluorinated copolymer (A). Further, such reactive functional groups may be of one type only or of two or more types. The types and content of the reactive functional groups may suitably be selected depending upon the type of the thermoplastic resin (B), functional groups of the thermoplastic resin (B), the desired characteristics, the molding method, etc.

The reactive functional groups may, for example, be at least one member selected from the group consisting of a carboxylic acid group, a group obtained by dehydration condensation of two carboxy groups in one molecule (hereinafter referred to as an acid anhydride group), a hydroxy group, a sulfonic acid group, an epoxy group, a cyano group, a carbonate group, an isocyanate group, an ester group, an amide group, an aldehyde group, an amino group, a hydrolyzable silyl group, a carbon-carbon double bond and a carboxylic acid halide group.

The carboxylic acid group means a carboxy group and its salt (—COOM¹). Here, M¹ is a metal atom or atomic group capable of forming a salt with a carboxylic acid.

The sulfonic acid group means a sulfo group and its salt (—SO₃M²). Here, M² is a metal atom or atomic group capable of forming a salt with sulfonic acid.

Among the reactive functional groups, preferred is at least one member selected from the group consisting of a carboxylic acid group, an acid anhydride group, a hydroxy group, an epoxy group, a carbonate group, an amino group, an amide group, a hydrolyzable silyl group, a carbon-carbon double bond and a carboxylic acid halide group, and more preferred is at least one member selected from the group consisting of a carboxylic acid group, an acid anhydride group, a hydroxy group, an amino group, an amide group and a carboxylic acid halide group.

The following methods may, for example, be mentioned as methods for introducing reactive functional groups to the fluorinated copolymer (A).

(i) A method of copolymerizing a monomer having a reactive functional group as one of other monomers at the time of polymerizing ethylene and TFE with other monomers.

(ii) A method of introducing a reactive functional group to a polymer terminal of the fluorinated copolymer (A) by using a polymerization initiator, a chain extender or the like having a reactive functional group at the time of copolymerizing ethylene and TFE, and, if necessary, other monomers.

(iii) A method of grafting, to the fluorinated copolymer (A), a compound (a grafting compound) having a reactive functional group and a functional group which can be grafted (such as an unsaturated bond).

The methods (i) to (iii) may be used in combination of two or more of them as the case requires. Among the methods (i) to (iii), the method (i) or (ii) is preferred from the viewpoint of the durability of the fluorinated copolymer (A).

Further, functional groups which may be introduced, as the case requires, in order to impart various functions to the fluorinated copolymer (A), other than the reactive functional groups, may be introduced to the fluorinated copolymer (A) in the same methods as the methods for introducing the reactive functional groups.

As the fluorinated copolymer (A), commercially available ETFE may be used. The following may, for example, be mentioned as commercially available ETFE.

Manufactured by Asahi Glass Company, Limited: Fluon (registered trademark) ETFE Series, Fluon (registered trademark) LM Series,

Manufactured by DAIKIN INDUSTRIES, LTD.: Neoflon (registered trademark),

Manufactured by Dyneon: Dyneon (registered trademark) ETFE,

Manufactured by DuPont: Tefzel (registered trademark), etc.

The melting point of the fluorinated copolymer (A) is preferably from 130° C. to 275° C., more preferably from 140° C. to 265° C., further preferably from 150° C. to 260° C., from the viewpoint of the solubility, strength, etc.

The melting point of the fluorinated copolymer (A) may be measured, for example, by a differential scanning calorimeter (DSC).

As the fluorinated copolymer (A), one type may be used alone, or two or more types may be used in combination.

(Thermoplastic resin (B))

The thermoplastic resin (B) is a thermoplastic resin other than the fluorinated copolymer (A).

The thermoplastic resin (B) may be one which is soluble in the medium (C), one, a part of which is soluble in the medium (C), or one which is not soluble at all, within a temperature range wherein the fluorinated copolymer (A) and the medium (C) exhibit a solution state. The thermoplastic resin (B) is preferably one which is soluble in the medium (C) from the viewpoint of the miscibility and compatibility with the fluorinated copolymer (A).

The thermoplastic resin (B) may, for example, be a fluorinated resin other than the fluorinated copolymer (A), or a hydrocarbon resin.

The fluorinated resin may, for example, be polytetrafluoroethylene (PTFE), an ethylene/chlorotrifluoroethylene copolymer (ECTFE), polyvinylidene fluoride (PVDF), polyvinyl fluoride (PVF), polychlorotrifluoroethylene (PCTFE) or a chlorotrifluoroethylene/vinyl ether copolymer.

The hydrocarbon resin may, for example, be polyethylene (PE), polypropylene (PP), poly(4-methyl-1-pentene) (PMP), poly(l-butene) (PB-1), polystyrene (PS), polyvinyl chloride (PVC), polyvinylidene chloride (PVDC), polymethyl methacrylate (PMMA), polyethyl methacrylate (PEMA), polybutyl methacrylate (PBMA), polyisobutyl methacrylate (PIBMA), polyhexyl methacrylate (PHMA), poly(2,2,3,3,3-pentafluoropropyl methacrylate) (PC3FMA), polyvinyl alcohol (PVAL), a methyl methacrylate/styrene copolymer (MS), a maleic anhydride/styrene copolymer (SMAH), an acrylonitrile/styrene copolymer (SAN), polyurethane (PU), polyoxymethylene (POM), polyvinyl acetal (PVAT), polyvinyl formal (PVFM), polyvinyl butyral (PVB), polyvinyl acetate (PVAC), an acrylonitrile/butadiene/styrene copolymer (ABS), an ethylene/vinyl acetate copolymer (EVA), an ethylene/acrylic acid copolymer (EAA), an ethylene/maleic anhydride copolymer (P(E-graft-MA)), a vinylidene chloride/vinyl chloride copolymer (P(VDC-VC)), poly(2,6-dimethyl-1,4-phenylene oxide) (PPO), polyamide 6 (PA6), polyamide 66 (PA66), polyamide 9T (PA9T), polyamide 11 (PA11), polyamide 12 (PA12), polyethylene terephthalate (PET), polytrimethylene terephthalate (PTT), polybutylene terephthalate (PBT), polysulfone (PSf), polyether sulfone (PES), polycarbonate (PC), polyether ether ketone (PEEK), polyphenylene sulfide (PPS), polyimide (PI), polyamidimide (PAI), polyetherimide (PEI), polyallylate (PAR), cycloolefin polymer (COP), or polylactic acid (PLA).

From the viewpoint of the usefulness of the fluorinated copolymer composition, the coating film and the molded product, the thermoplastic resin (B) is preferably polyvinylidene fluorine (PVDF), polychlorotrifluoroethylene (PCTFE), a chlorotrifluoroethylene/vinyl ether copolymer, polyethylene, polypropylene, poly(4-methyl-1-pentene), polystyrene, polyvinyl chloride, polymethyl methacrylate, polyethyl methacrylate, polybutyl methacrylate, polyisobutyl methacrylate, poly(2,2,3,3,3-pentafluoropropyl)methacrylate) (PC3FMA), a methyl methacrylate/styrene copolymer, an acrylonitrile/butadiene/styrene copolymer, an ethylene/vinyl acetate copolymer (EVA), an ethylene/acrylic acid copolymer (EAA), an ethylene/maleic anhydride copolymer (P(E-graft-MA)), a vinylidene chloride/vinyl chloride copolymer (P(VDC-VC)), poly(2,6-dimethyl-1,4-phenylene oxide), polyamide 11, polyamide 12, polybutylene terephthalate, polysulfone, polyether sulfone or polyether ether ketone.

In a case where the fluorinated copolymer (A) has reactive functional groups, the thermoplastic resin (B) is preferably one having functional groups capable of reacting with such reactive functional groups, from the viewpoint of the miscibility and compatibility with the fluorinated copolymer (A).

As the thermoplastic resin (B), one type may be used alone, or two or more types may be used in combination.

### (Medium (C))

The medium (C) is a solvent capable of dissolving at least the fluorinated copolymer (A).

The medium (C) may be one which dissolves the thermoplastic resin (B), or one which does not dissolve the thermoplastic resin (B) partially or totally, in a temperature range wherein the fluorinated copolymer (A) and the medium (C) exhibit a solution state. From the viewpoint of the miscibility and compatibility with the fluorinated copolymer (A) and the thermoplastic resin (B), it is preferably one which dissolves the thermoplastic resin (B).

Whether or not a certain solvent is a medium (C) capable of dissolving at least the fluorinated copolymer (A), can be judged depending upon whether or not the polarity of the solvent is within a specific range as described below. In the present invention, as the medium (C), it is preferred to select a solvent having a polarity within a specific range, based on Hansen solubility parameters.

Hansen solubility parameters are ones such that the solubility parameter introduced by Hildebrand is divided by Hansen into three components of dispersion component δd, polar component δp and hydrogen bonding component δh and represented in a three dimensional space. The dispersion component δd represents the effect by dispersion force, the polar component δp represents the effect by dipolar intermolecular force, and the hydrogen bonding component δh represents the effect by hydrogen bonding force. In the three dimensional space, as the coordinate of a specific resin X is closer to the coordinate of a certain solvent, the resin X is readily soluble in the solvent.

The definition and calculation of Hansen solubility parameters are disclosed in the following literature.

“Hansen Solubility Parameter: A Users Handbook (CRC Press, 2007)”, edited by Charles M. Hansen.

Further, by using a computer software “Hansen Solubility Parameters in Practice (HSPiP)”, also with respect to solvents, of which no parameter values, etc. are known in literatures, Hansen solubility parameters can be estimated simply from their chemical structures. In the present invention, a solvent to be used is selected by using HSPiP version 3 by employing, with respect to a solvent registered in the database, its values and employing, with respect to a solvent not registered, its estimated values.

Hansen solubility parameters for a certain resin X can be determined by a solubility test wherein samples of such a resin X are dissolved in many different solvents, of which Hansen solubility parameters have already been known, and the solubilities are measured. Specifically, such a sphere (solubility sphere) is to be found out whereby all three dimensional points of the solvents which dissolved the resin X among the solvents used for the above solubility test are included inside of the sphere, and points of the solvents which did not dissolve the resin X are located outside the sphere, and the central coordinate of such a solubility sphere is taken as Hansen solubility parameters for the resin X.

And, in a case where Hansen solubility parameters of a certain solvent not used for the solubility test are (δd, δp, δh), if such coordinates are included inside of the solubility sphere, such a solvent is considered to dissolve the resin X. On the other hand, if such coordinates are located outside of the solubility sphere, such a solvent is considered not to be able to dissolve the resin X.

In the present invention, diisopropyl ketone being a solvent which dissolves at least the fluorinated copolymer (A) at a temperature of not higher than the melting point and which is most suitable to disperse the fluorinated copolymer (A) at room temperature in the form of micro particles without agglomerating it, is assumed to be a substance having a nature closest to the fluorinated copolymer (A) as Hansen solubility parameters. And, using diisopropyl ketone as the standard (the center of the solubility sphere), a group of solvents which are located within a certain distance from the coordinates (15.7, 5.7 and 4.3) of Hansen solubility parameters of diisopropyl ketone (i.e. inside of the solubility sphere) can be used as the medium (C).

Specifically, the following formula (1) to estimate the distance between the coordinates of diisopropyl ketone and the coordinates of a certain solvent, is prepared based on the formula (Ra)²=4×(δd2−δd1)²+(δp2−δp1)²+(δh2−δh1)² well known as a formula to obtain a distance Ra between two points in the three dimensional space of Hansen solubility parameters, and R represented by the following formula (1) is taken as the dissolution index for the fluorinated copolymer (A).

R=4×(δd−15.7)²+(δp−5.7)²+(δh−4.3)² (1)

wherein δd, δp and δh represent the dispersion component, the polar component and the hydrogen bonding component [(MPa)^{1/2}], respectively, in Hansen solubility parameters of the solvent.

As the medium (C), one having a dissolution index (R) of less than 49 is preferred, and one having a dissolution index (R) of less than 36 is more preferred. The medium (C) having a dissolution index (R) within such a range, has a high affinity with the fluorinated copolymer (A) and provides a high solubility and dispersibility of the fluorinated copolymer (A).

Even in a case where the medium (C) is a solvent mixture having two or more solvents mixed, the dissolution index (R) of such a solvent mixture may be used as the dissolution index for the fluorinated copolymer (A). For example, average Hansen solubility parameters may be obtained from the mixing ratio (volume ratio) of the mixed solvents, and from such average values, the dissolution index (R) is calculated.

Solvents which may be used as the medium (C), include, for example, C₃₋₁₀ ketones, esters, carbonates, ethers, nitriles, fluorinated aromatic compounds or heterocyclic compounds having at least two fluorine atoms (such as a fluorinated benzonitrile, a fluorinated benzoic acid and its ester, a fluorinated nitrobenzene, a fluorinated phenyl alkyl alcohol, an ester of fluorinated phenol, a fluorinated aromatic ketone, a fluorinated aromatic ether, a fluorinated pyridine compound, a fluorinated aromatic carbonate, a perfluoroalkyl-substituted benzene, a perfluorobenzene, a polyfluoroalkyl ester of benzoic acid, and a polyfluoroalkyl ester of phthalic acid), hydrofluorocarbons, hydrofluoroethers, and hydrofluoroalcohols. C₃₋₁₀ ketones, esters and fluorinated aromatic compounds are preferred.

Specifically, the following solvents may be mentioned as the medium (C) wherein the dissolution index (R) is less than 49.

TABLE 1

| Solvents | δd | δp | δh | R | |
|---|---|---|---|---|---|
| Acetone | 15.5 | 10.4 | 7.0 | 29.5 | DB |
| Methyl ethyl ketone | 16.0 | 9.0 | 5.1 | 11.9 | DB |
| 2-Pentanone | 16.0 | 7.6 | 4.7 | 4.1 | DB |
| Methyl isopropyl ketone | 15.8 | 6.8 | 5.0 | 1.7 | calc |
| 2-Hexanone | 15.3 | 6.1 | 4.1 | 0.8 | DB |
| Methyl isobutyl ketone | 15.3 | 6.1 | 4.1 | 0.8 | DB |
| Pinacolin | 15.2 | 5.7 | 5.3 | 2.0 | calc |
| 2-Heptanone | 16.2 | 5.7 | 4.1 | 1.0 | DB |
| 4-Heptanone | 15.8 | 7.6 | 4.9 | 4.0 | DB |
| Diisopropyl ketone | 15.7 | 5.7 | 4.3 | 0 | calc |
| Isoamyl methyl ketone | 16.0 | 5.7 | 4.1 | 0.4 | DB |
| 2-Octanone | 16.1 | 4.7 | 4.0 | 1.7 | calc |
| 2-Nonanone | 16.0 | 5.5 | 3.8 | 0.7 | calc |
| Diisobutyl ketone | 16.0 | 3.7 | 4.1 | 4.4 | DB |
| 2-Decanone | 16.1 | 4.6 | 3.8 | 2.1 | calc |
| Cyclohexanone | 17.8 | 8.4 | 5.1 | 25.6 | DB |
| 2-Methylcyclohexanone | 17.6 | 7.8 | 4.7 | 19.0 | DB |
| 3-Methylcyclohexanone | 17.7 | 7.7 | 4.7 | 20.2 | DB |
| 4-Ethylcyclohexanone | 17.3 | 7.7 | 4.5 | 14.3 | calc |
| 2,6-Dimethylcyclohexanone | 17.3 | 8.4 | 5.3 | 18.5 | calc |
| 3,3,5-Trimethylcyclohexanone | 17.0 | 7.0 | 5.0 | 8.9 | calc |
| 4-tert-butylcyclohexanone | 16.5 | 6.4 | 4.6 | 3.1 | calc |
| Cycloheptanone | 17.2 | 10.6 | 4.8 | 33.3 | DB |
| Isophorone | 17.0 | 8.0 | 5.0 | 12.5 | DB |
| (−)-Fenchone | 17.6 | 7.5 | 3.9 | 17.8 | calc |
| Ethyl formate | 15.5 | 8.4 | 8.4 | 24.3 | DB |
| Propyl formate | 15.5 | 7.1 | 8.6 | 20.6 | DB |
| Isopropyl formate | 15.4 | 6.6 | 7.4 | 10.8 | calc |
| Butyl formate | 15.7 | 6.5 | 9.2 | 24.7 | DB |
| Isobutyl formate | 15.5 | 6.5 | 6.7 | 6.6 | DB |
| sec-Butyl formate | 15.2 | 5.3 | 6.6 | 6.5 | calc |
| t-Butyl formate | 14.8 | 5.4 | 7.4 | 12.9 | calc |
| Amyl formate | 15.7 | 5.0 | 6.2 | 4.1 | calc |
| Isoamyl formate | 15.3 | 4.9 | 6.3 | 5.3 | calc |
| Hexyl formate | 15.8 | 4.5 | 5.6 | 3.2 | calc |
| Cyclohexyl formate | 16.8 | 4.0 | 6.1 | 11.0 | calc |
| Heptyl formate | 15.8 | 5.3 | 5.2 | 1.0 | calc |
| Octyl formate | 15.9 | 4.4 | 5.1 | 2.5 | calc |
| 2-Ethylhexyl formate | 15.7 | 3.8 | 5.2 | 4.4 | calc |
| Nonyl formate | 16.0 | 4.1 | 4.9 | 3.3 | calc |
| Methyl acetate | 15.5 | 7.2 | 7.6 | 13.3 | DB |
| Ethyl acetate | 15.8 | 5.3 | 7.2 | 8.6 | DB |

calc: calculated value,
DB: data base value

TABLE 2

| Solvents | δd | δp | δh | R | |
|---|---|---|---|---|---|
| Propyl acetate | 15.3 | 4.3 | 7.6 | 13.5 | DB |
| Isopropyl acetate | 14.9 | 4.5 | 8.2 | 19.2 | DB |
| Butyl acetate | 15.8 | 3.7 | 6.3 | 8.0 | DB |
| Isobutyl acetate | 15.1 | 3.7 | 6.3 | 9.4 | DB |
| sec-Butyl acetate | 15.0 | 3.7 | 7.6 | 16.9 | DB |
| t-Butyl acetate | 15.0 | 3.7 | 6.0 | 8.9 | DB |
| Amyl acetate | 15.8 | 3.3 | 6.1 | 9.0 | DB |
| Isoamyl acetate | 15.3 | 3.1 | 7.0 | 14.7 | DB |
| Hexyl acetate | 15.8 | 2.9 | 5.9 | 10.4 | DB |
| Cyclohexyl acetate | 16.9 | 2.8 | 5.6 | 15.9 | calc |
| Heptyl acetate | 15.8 | 2.9 | 5.5 | 9.3 | DB |
| Octyl acetate | 15.8 | 2.9 | 5.1 | 8.5 | DB |
| 2-Ethylhexyl acetate | 15.8 | 2.9 | 5.1 | 8.5 | DB |
| 2,2,2-Trifluoroethyl acetate | 15.4 | 5.3 | 6.0 | 3.4 | calc |
| 2,2,3,3-Tetrafluoropropyl acetate | 15.1 | 2.9 | 4.8 | 9.5 | calc |
| 2,2,3,3,3-Pentafluoropropyl acetate | 13.3 | 3.1 | 4.5 | 29.8 | calc |
| 1,1,1,3,3,3-Hexafluoro-2-propyl acetate | 15.1 | 4.9 | 4.6 | 2.2 | calc |
| 2,2-Bis(trifluoromethyl)propyl acetate | 15.3 | 3.1 | 4.6 | 7.5 | calc |
| 2,2,3,3,4,4,4-Heptafluorobutyl acetate | 13.8 | 2.4 | 3.6 | 25.8 | calc |
| 2,2,3,4,4,4-Hexafluorobutyl acetate | 15.0 | 2.6 | 3.8 | 11.8 | calc |
| 2,2,3,3,4,4,5,5,5-Nonafluoropentyl acetate | 14.2 | 1.9 | 3.0 | 25.1 | calc |
| 2,2,3,3,4,4,5,5-Octafluoropentyl acetate | 15.5 | 1.7 | 3.1 | 17.6 | calc |
| 3,3,4,4,5,5,6,6,6-Nonafluorohexyl acetate | 14.4 | 1.8 | 2.8 | 24.2 | calc |
| 4,4,5,5,6,6,7,7,7-Nonafluoroheptyl acetate | 14.5 | 2.5 | 2.7 | 18.6 | calc |
| 2,2,3,3,4,4,5,5,6,6,7,7-Dodecafluoroheptyl | 15.8 | 1.0 | 2.1 | 27.0 | calc |
| acetate | | | | | |
| 7,7,8,8,8-Pentafluorooctyl acetate | 14.4 | 2.6 | 3.7 | 16.7 | calc |
| 3,3,4,4,5,5,6,6,7,7,8,8,8- | 14.8 | 1.1 | 2.0 | 29.7 | calc |
| Tridecafluorooctyl acetate | | | | | |
| Methyl propionate | 15.5 | 6.5 | 7.7 | 12.4 | DB |
| Ethyl propionate | 15.5 | 6.1 | 4.9 | 0.7 | DB |
| Propyl propionate | 15.5 | 5.6 | 5.7 | 2.1 | DB |
| Isopropyl propionate | 15.7 | 4.2 | 5.9 | 4.8 | calc |
| Butyl propionate | 15.7 | 5.5 | 5.9 | 2.6 | DB |
| Isobutyl propionate | 15.5 | 3.7 | 5.5 | 5.6 | calc |
| sec-Butyl propionate | 15.6 | 3.5 | 5.4 | 6.1 | calc |
| t-Butyl propionate | 15.2 | 3.6 | 6.1 | 8.7 | calc |
| Amyl propionate | 15.8 | 5.2 | 5.7 | 2.3 | DB |
| Isoamyl propionate | 15.7 | 5.2 | 5.6 | 1.9 | DB |
| Hexyl propionate | 16.0 | 3.2 | 4.8 | 6.9 | calc |
| Cyclohexyl propionate | 16.8 | 2.6 | 5.1 | 15.1 | calc |
| Heptyl propionate | 15.9 | 3.9 | 4.5 | 3.4 | calc |

calc: calculated value,
DB: data base value

TABLE 3

| Solvents | δd | δp | δh | R | |
|---|---|---|---|---|---|
| Methyl butyrate | 15.8 | 4.8 | 6.7 | 6.6 | calc |
| Ethyl butyrate | 15.5 | 5.6 | 5.0 | 0.7 | DB |
| Propyl butyrate | 15.8 | 4.3 | 5.6 | 3.7 | calc |
| Isopropyl butyrate | 15.8 | 4.2 | 5.6 | 4.0 | calc |
| Butyl butyrate | 15.6 | 2.9 | 5.6 | 9.6 | DB |
| Isobutyl butyrate | 15.6 | 3.7 | 5.2 | 4.9 | calc |
| sec-Butyl butyrate | 15.6 | 3.5 | 5.2 | 5.7 | calc |
| t-Butyl butyrate | 15.3 | 3.6 | 5.8 | 7.3 | calc |
| Amyl butyrate | 15.9 | 3.5 | 5.0 | 5.5 | calc |
| Isoamyl butyrate | 15.7 | 3.4 | 5.1 | 5.9 | calc |
| Hexyl butyrate | 16.0 | 3.2 | 4.7 | 6.8 | calc |
| Cyclohexyl butyrate | 16.7 | 2.7 | 4.9 | 13.4 | calc |
| Methyl isobutyrate | 15.7 | 4.7 | 6.6 | 6.3 | calc |
| Ethyl isobutyrate | 15.7 | 4.2 | 5.9 | 4.8 | calc |
| Propyl isobutyrate | 15.8 | 4.2 | 5.6 | 4.0 | calc |
| Isopropyl isobutyrate | 15.7 | 4.1 | 5.5 | 4.0 | calc |
| Butyl isobutyrate | 15.8 | 3.7 | 5.1 | 4.7 | calc |
| Isobutyl isobutyrate | 15.1 | 2.8 | 5.8 | 12.1 | DB |
| sec-Butyl isobutyrate | 15.6 | 3.5 | 5.2 | 5.7 | calc |
| t-Butyl isobutyrate | 15.2 | 3.6 | 5.7 | 7.4 | calc |
| Amyl isobutyrate | 15.9 | 3.4 | 5.0 | 5.9 | calc |
| Isoamyl isobutyrate | 15.6 | 3.4 | 5.0 | 5.8 | calc |
| Hexyl isobutyrate | 15.9 | 3.2 | 4.6 | 6.5 | calc |
| Cyclohexyl isobutyrate | 16.7 | 2.7 | 4.9 | 13.4 | calc |
| Methyl valerate | 15.9 | 4.1 | 6.0 | 5.6 | calc |
| Ethyl valerate | 15.9 | 3.8 | 5.4 | 5.0 | calc |
| Propyl valerate | 15.9 | 3.8 | 5.2 | 4.6 | calc |
| Isopropyl valerate | 15.8 | 3.7 | 5.1 | 4.7 | calc |
| Butyl valerate | 15.9 | 3.4 | 4.8 | 5.7 | calc |
| Isobutyl valerate | 15.6 | 3.3 | 4.9 | 6.2 | calc |
| sec-Butyl valerate | 15.7 | 3.1 | 4.8 | 7.0 | calc |
| t-Butyl valerate | 15.4 | 3.3 | 5.3 | 7.1 | calc |
| Amyl valerate | 16.0 | 3.1 | 4.7 | 7.3 | calc |
| Isoamyl valerate | 15.7 | 3.1 | 4.7 | 6.9 | calc |
| Methyl isovalerate | 15.5 | 4.0 | 6.0 | 5.9 | calc |
| Ethyl isovalerate | 15.5 | 3.7 | 5.5 | 5.6 | calc |
| Propyl isovalerate | 15.6 | 3.7 | 5.2 | 4.9 | calc |
| Isopropyl isovalerate | 15.5 | 3.6 | 5.2 | 5.4 | calc |
| Butyl isovalerate | 15.6 | 3.3 | 4.9 | 6.2 | calc |
| Isobutyl isovalerate | 15.4 | 3.2 | 4.9 | 7.0 | calc |
| sec-Butyl isovalerate | 15.4 | 3.1 | 4.9 | 7.5 | calc |
| t-Butyl isovalerate | 15.1 | 3.2 | 5.4 | 8.9 | calc |

calc: calculated value,
DB: data base value

TABLE 4

| Solvents | δd | δp | δh | R | |
|---|---|---|---|---|---|
| Amyl isovalerate | 15.7 | 3.1 | 4.7 | 6.9 | calc |
| Isoamyl isovalerate | 15.5 | 3.0 | 4.8 | 7.7 | calc |
| Methyl hexanoate | 16.0 | 3.7 | 5.7 | 6.3 | calc |
| Ethyl hexanoate | 15.5 | 3.2 | 5.9 | 9.0 | DB |
| Propyl hexanoate | 15.9 | 3.5 | 5.0 | 5.5 | calc |
| Isopropyl hexanoate | 15.9 | 3.4 | 5.0 | 5.9 | calc |
| Butyl hexanoate | 16.0 | 3.1 | 4.7 | 7.3 | calc |
| Isobutyl hexanoate | 15.7 | 3.1 | 4.7 | 6.9 | calc |
| sec-Butyl hexanoate | 15.8 | 2.9 | 4.7 | 8.0 | calc |
| t-Butyl hexanoate | 15.5 | 3.0 | 5.2 | 8.3 | calc |
| Methyl heptanoate | 16.0 | 3.4 | 5.2 | 6.5 | calc |
| Ethyl heptanoate | 16.0 | 3.2 | 4.8 | 6.9 | calc |
| Propyl heptanoate | 16.0 | 3.2 | 4.7 | 6.8 | calc |
| Isopropyl heptanoate | 15.9 | 3.2 | 4.6 | 6.5 | calc |
| Methyl octanoate | 16.0 | 4.2 | 4.8 | 2.9 | calc |
| Ethyl octanoate | 15.9 | 3.9 | 4.5 | 3.4 | calc |
| Methyl nonanoate | 16.1 | 3.5 | 4.8 | 5.7 | calc |
| Methyl cyclohexanecarboxylate | 16.9 | 2.8 | 5.6 | 15.9 | calc |
| Ethyl cyclohexanecarboxylate | 16.8 | 2.6 | 5.1 | 15.1 | calc |
| Propyl cyclohexanecarboxylate | 16.7 | 2.7 | 4.9 | 13.4 | calc |
| Isopropyl cyclohexanecarboxylate | 16.7 | 2.7 | 4.9 | 13.4 | calc |
| 2,2,2-Trifluoroethyl cyclohexane- | 16.5 | 3.0 | 4.5 | 9.9 | calc |
| carboxylate | | | | | |
| Bis(2,2,2-trifluoroethyl) succinate | 15.8 | 5.1 | 6.0 | 3.3 | calc |
| Bis(2,2,2-trifluoroethyl) glutarate | 15.8 | 5.6 | 5.7 | 2.0 | calc |
| Bis(2,2,2-trifluoroethyl) adipate | 15.9 | 4.9 | 5.6 | 2.5 | calc |
| Methyl trifluoroacetate | 15.3 | 6.0 | 6.4 | 5.1 | calc |
| Ethyl trifluoroacetate | 15.3 | 5.3 | 5.6 | 2.5 | calc |
| Propyl trifluoroacetate | 15.4 | 5.1 | 5.4 | 1.9 | calc |
| Isopropyl trifluoroacetate | 15.3 | 5.0 | 5.3 | 2.1 | calc |
| Butyl trifluoroacetate | 15.5 | 4.5 | 4.8 | 1.9 | calc |
| Isobutyl trifluoroacetate | 15.2 | 4.4 | 4.9 | 3.1 | calc |
| sec-Butyl trifluoroacetate | 15.2 | 4.2 | 4.9 | 3.6 | calc |
| t-Butyl trifluoroacetate | 14.9 | 4.3 | 5.5 | 6.0 | calc |
| Amyl trifluoroacetate | 15.6 | 4.1 | 4.7 | 2.8 | calc |
| Isoamyl trifluoroacetate | 15.3 | 4.0 | 4.8 | 3.8 | calc |
| Hexyl trifluoroacetate | 15.7 | 3.8 | 4.4 | 3.6 | calc |
| Cyclohexyl trifluoroacetate | 16.5 | 3.3 | 4.6 | 8.4 | calc |
| Heptyl trifluoroacetate | 15.7 | 4.5 | 4.1 | 1.5 | calc |
| Octyl trifluoroacetate | 15.8 | 3.8 | 4.1 | 3.7 | calc |
| 2-Ethylhexyl trifluoroacetate | 15.7 | 3.3 | 4.2 | 5.8 | calc |
| Methyl difluoroacetate | 16.1 | 7.5 | 6.3 | 7.9 | calc |
| Ethyl difluoroacetate | 16.0 | 6.5 | 5.5 | 2.4 | calc |

calc: calculated value,
DB: data base value

TABLE 5

| Solvents | δd | δp | δh | R | |
|---|---|---|---|---|---|
| Methyl perfluoropropionate | 12.9 | 3.4 | 4.7 | 36.8 | calc |
| Ethyl perfluoropropionate | 13.2 | 3.1 | 4.3 | 31.8 | calc |
| Methyl perfluorobutanoate | 13.5 | 2.6 | 3.7 | 29.3 | calc |
| Ethyl perfluorobutanoate | 13.7 | 2.4 | 3.4 | 27.7 | calc |
| Methyl perfluoropentanoate | 14.0 | 2.0 | 3.0 | 26.9 | calc |
| Ethyl perfluoropentanoate | 14.1 | 1.9 | 2.8 | 26.9 | calc |
| Methyl 2,2,3,3,4,4,5,5-octafluoro- | 15.4 | 1.8 | 3.1 | 17.0 | calc |
| pentanoate | | | | | |
| Ethyl 2,2,3,3,4,4,5,5-octafluoro- | 15.5 | 1.7 | 2.9 | 18.1 | calc |
| pentanoate | | | | | |
| Methyl perfluoroheptanoate | 14.6 | 1.3 | 2.0 | 29.5 | calc |
| Ethyl perfluoroheptanoate | 14.7 | 1.2 | 2.0 | 29.5 | calc |
| Methyl 2,2,3,3,4,4,5,5,6,6,7,7- | 15.7 | 1.1 | 1.2 | 30.8 | calc |
| dodecafluoroheptanoate | | | | | |
| Ethyl 2,2,3,3,4,4,5,5,6,6,7,7- | 15.7 | 1.1 | 2.0 | 26.5 | calc |
| dodecafluoroheptanoate | | | | | |
| Methyl 2-trifluoromethyl-3,3,3- | 15.1 | 4.9 | 4.6 | 2.2 | calc |
| trifluoropropionate | | | | | |
| Ethyl 2-trifluoromethyl-3,3,3- | 15.1 | 4.5 | 4.3 | 2.9 | calc |
| trifluoropropionate | | | | | |
| 2-Ethoxyethyl acetate | 15.9 | 4.7 | 10.6 | 40.9 | DB |
| 2-Propoxyethyl acetate | 16.0 | 5.2 | 7.2 | 9.0 | calc |
| 2-Butoxyethyl acetate | 15.3 | 7.5 | 6.8 | 10.1 | DB |
| 2-Pentyloxyethyl acetate | 16.1 | 4.2 | 6.3 | 6.9 | calc |
| 2-Hexyloxyethyl acetate | 16.1 | 3.9 | 5.9 | 6.4 | calc |
| 1-Methoxy-2-acetoxypropane | 15.6 | 5.6 | 9.8 | 30.0 | DB |
| 1-Ethoxy-2-acetoxypropane | 15.6 | 6.3 | 7.7 | 12.0 | DB |
| 1-Propoxy-2-acetoxypropane | 15.9 | 4.6 | 6.6 | 6.7 | calc |
| 1-Butoxy-2-acetoxypropane | 15.9 | 4.2 | 6.1 | 5.7 | calc |
| 1-Pentyloxy-2-acetoxypropane | 16.0 | 3.9 | 5.9 | 6.2 | calc |
| 3-Methoxybutyl acetate | 15.3 | 4.1 | 8.1 | 17.6 | DB |
| 3-Ethoxybutyl acetate | 15.9 | 4.3 | 6.4 | 6.5 | calc |
| 3-Propoxybutyl acetate | 15.9 | 4.2 | 6.1 | 5.7 | calc |
| 3-Butoxybutyl acetate | 16.0 | 3.9 | 5.7 | 5.6 | calc |
| 3-Methoxy-3-methylbutyl acetate | 15.3 | 3.8 | 7.7 | 15.8 | DB |
| 3-Ethoxy-3-methylbutyl acetate | 15.8 | 4.7 | 6.0 | 3.9 | calc |
| 3-Propoxy-3-methylbutyl acetate | 15.8 | 4.7 | 5.8 | 3.3 | calc |
| 4-Methoxybutyl acetate | 16.0 | 5.4 | 6.8 | 6.7 | calc |
| 4-Ethoxybutyl acetate | 16.0 | 5.0 | 6.3 | 4.9 | calc |
| 4-Propoxybutyl acetate | 16.0 | 4.9 | 6.0 | 3.9 | calc |
| 4-Butoxybutyl acetate | 16.0 | 4.4 | 5.6 | 3.7 | calc |
| 2-(Perfluoropropyloxy)-2,3,3,3- | 13.7 | 2.8 | 3.2 | 25.6 | calc |
| tetrafluoropropyl acetate | | | | | |

calc: calculated value,
DB: data base value

TABLE 6

| Solvents | δd | δp | δh | R | |
|---|---|---|---|---|---|
| Dimethyl carbonate | 15.5 | 8.6 | 9.7 | 37.7 | DB |
| Ethylmethyl carbonate | 15.3 | 7.3 | 6.1 | 6.4 | calc |
| Diethyl carbonate | 15.1 | 6.3 | 3.5 | 2.4 | DB |
| Dipropyl carbonate | 15.5 | 5.8 | 4.9 | 0.5 | calc |
| Dibutyl carbonate | 15.6 | 4.7 | 4.2 | 1.1 | calc |
| Bis(2,2,2-trifluoroethyl) carbonate | 14.9 | 6.5 | 3.8 | 3.4 | calc |
| Bis(2,2,3,3-tetrafluoropropyl) carbonate | 14.5 | 2.9 | 2.6 | 16.5 | calc |
| Tetrahydrofuran | 16.8 | 5.7 | 8.0 | 18.5 | DB |
| Butyronitrile | 15.3 | 12.4 | 5.1 | 46.2 | DB |
| Isobutyronitrile | 15.7 | 10.5 | 4.5 | 23.1 | calc |
| Valeronitrile | 15.3 | 11.0 | 4.8 | 29.0 | DB |
| Isovaleronitrile | 15.4 | 8.7 | 4.1 | 9.4 | calc |
| Capronitrile | 16.0 | 7.7 | 3.9 | 4.5 | calc |
| Isocapronitrile | 15.6 | 7.6 | 4.0 | 3.7 | calc |
| Heptanenitrile | 16.0 | 6.8 | 3.6 | 2.1 | calc |
| Octanenitrile | 16.0 | 7.4 | 3.3 | 4.3 | calc |
| Nonanenitrile | 16.1 | 6.3 | 3.4 | 1.8 | calc |
| Decanenitrile | 16.1 | 5.8 | 3.4 | 1.5 | calc |
| Pentafluorobenzonitrile | 18.3 | 7.7 | 1.1 | 41.3 | calc |
| 3,5-Bis(trifluoromethyl)benzonitrile | 17.9 | 8.7 | 1.5 | 36.2 | calc |
| 2-(Trifluoromethyl)benzonitrile | 18.0 | 10.0 | 2.6 | 42.5 | calc |
| 3-(Trifluoromethyl)benzonitrile | 18.0 | 8.5 | 1.9 | 34.8 | calc |
| 3-(Trifluoromethoxy)benzonitrile | 18.0 | 9.7 | 4.5 | 37.2 | calc |
| Methyl pentafluorobenzoate | 17.8 | 6.6 | 2.2 | 22.9 | calc |
| Ethyl pentafluorobenzoate | 17.5 | 6.0 | 2.0 | 18.3 | calc |
| Methyl 3-(trifluoromethyl)benzoate | 17.6 | 7.4 | 2.7 | 19.9 | calc |
| Methyl 4-(trifluoromethyl)benzoate | 17.8 | 8.3 | 3.2 | 25.6 | calc |
| Methyl 3,5-bis(trifluoromethyl)benzoate | 17.5 | 7.8 | 2.2 | 21.8 | calc |
| Pentafluoronitrobenzene | 18.6 | 5.0 | 1.9 | 39.9 | calc |
| 1-(Pentafluorophenyl)ethanol | 17.9 | 4.0 | 7.8 | 34.5 | calc |
| Pentafluorophenyl formate | 18.0 | 4.7 | 4.2 | 22.2 | calc |
| Pentafluorophenyl acetate | 18.0 | 3.4 | 3.9 | 26.6 | calc |
| Pentafluorophenyl propionate | 17.7 | 3.2 | 3.6 | 22.7 | calc |
| Pentafluorophenyl butanoate | 17.6 | 3.2 | 3.6 | 21.2 | calc |
| Pentafluorophenyl pentanoate | 17.5 | 2.9 | 3.4 | 21.6 | calc |
| 2′,3′,4′,5′,6′-Pentafluoroacetophenone | 18.5 | 6.6 | 2.8 | 34.4 | calc |
| 3′,5′-Bis(trifluoromethyl)acetophenone | 18.0 | 7.8 | 2.7 | 28.1 | calc |
| 3′-(Trifluoromethyl)acetophenone | 18.2 | 7.4 | 3.3 | 28.9 | calc |
| Pentafluoroanisole | 17.9 | 3.5 | 3.7 | 24.6 | calc |
| 3,5-B is(trifluoromethyl)anisole | 17.6 | 5.6 | 3.3 | 15.5 | calc |
| Pentafluoropyridine | 15.4 | 8.0 | 4.8 | 5.9 | calc |
| Benzotrifluoride | 17.5 | 8.8 | 0.0 | 41.1 | DB |

calc: calculated value,
DB: data base value

TABLE 7

| Solvents | δd | δp | δh | R | |
|---|---|---|---|---|---|
| 4-Chlorobenzotrifluoride | 18.4 | 5.5 | 2.6 | 32.1 | calc |
| 1,3-Bis(trifluoromethyl)benzene | 17.0 | 6.8 | 0.0 | 26.5 | calc |
| Perfluorotoluene | 17.3 | 2.5 | 0.3 | 36.5 | calc |
| 2,2,2-Trifluoroethyl benzoate | 17.5 | 7.8 | 3.4 | 18.2 | calc |
| 2,2,3,3-Tetrafluoropropyl benzoate | 17.1 | 5.7 | 2.8 | 10.1 | calc |
| 2,2,3,3,3-Pentafluoropropyl benzoate | 15.6 | 5.7 | 2.7 | 2.6 | calc |
| 1,1,1,3,3,3-Hexafluoro-2-propyl benzoate | 16.9 | 7.0 | 2.8 | 9.7 | calc |
| 2,2-Bis(trifluoromethyl)propyl benzoate | 16.8 | 5.2 | 3.1 | 6.5 | calc |
| 2,2,3,3,4,4,4-Heptafluorobutyl benzoate | 15.7 | 4.8 | 2.2 | 5.2 | calc |
| 2,2,3,4,4,4-Hexafluorobutyl benzoate | 16.7 | 5.1 | 2.3 | 8.4 | calc |
| 2,2,3,3,4,4,5,5,5-Nonafluoropentyl | 15.8 | 4.2 | 1.8 | 8.5 | calc |
| benzoate | | | | | |
| 2,2,3,3,4,4,5,5-Octafluoropentyl benzoate | 17.0 | 4.1 | 1.9 | 15.1 | calc |
| Bis(2,2,2-trifluoroethyl)phthalate | 17.0 | 9.8 | 3.4 | 24.4 | calc |
| 5-(Perfluorobutyl)bicyclo[2.2.1]-2-heptene | 15.4 | 0.7 | 1.2 | 35.0 | calc |
| 5-(Perfluorohexyl)bicyclo[2.2.1]-2- | 15.7 | 0.3 | 0.7 | 42.1 | calc |
| heptene | | | | | |
| 5-(Perfluorobutyl)bicyclo[2.2.1]heptane | 15.5 | 1.0 | 1.0 | 33.1 | calc |
| 5-(Perfluorohexyl)bicyclo[2.2.1]heptane | 15.7 | 0.5 | 0.6 | 40.7 | calc |
| HFC-c447ef(1,1,2,2,3,3,4- | 14.7 | 2.1 | 3.1 | 18.4 | calc |
| heptafluorocyclopentane) | | | | | |
| 1,1,1,2,3,3-Hexafluoro-4-(1,1,2,3,3,3- | 14.3 | 1.4 | 1.2 | 35.9 | calc |
| hexafluoropropoxy)pentane | | | | | |
| 2,2,3,4,4,4-Hexafluoro-1-butanol | 14.6 | 3.6 | 8.3 | 25.3 | calc |
| 2,2,3,3,4,4,5,5-Octafluoro-1-pentanol | 15.3 | 2.2 | 6.7 | 18.7 | calc |
| 2,2-Bis(trifluoromethyl)-1-propanol | 15.0 | 4.0 | 8.6 | 23.3 | calc |
| 3,3,4,4,5,5,6,6,6-Nonafluoro-1-hexanol | 14.0 | 2.2 | 5.8 | 26.1 | calc |
| 2,3,3,3-Tetrafluoro-2- | 13.2 | 3.5 | 6.0 | 32.7 | calc |
| (perfluoropropyloxy)-1-propanol | | | | | |
| 4,4,5,5,6,6,7,7,7-Nonafluoro-1-heptanol | 14.1 | 3.1 | 5.4 | 18.2 | calc |
| 2,2,3,3,4,4,5,5,6,6,7,7-Dodecafluoro- | 15.7 | 1.3 | 4.6 | 19.5 | calc |
| 1-heptanol | | | | | |
| 3,3,4,4,5,5,6,6,7,7,8,8,8-Tridecafluoro- | 14.6 | 1.4 | 4.2 | 23.3 | calc |
| 1-octanol | | | | | |
| 7,7,8,8,8-Pentafluoro-1-octanol | 14.1 | 3.2 | 6.6 | 21.8 | calc |
| 4,4,5,5,6,6,7,7,8,8,9,9,9-Tridecafluoro- | 14.7 | 2.1 | 4.0 | 17.1 | calc |
| 1-nonanol | | | | | |
| 7,8,8,8-Tetrafluoro-7-(trifluoromethyl)- | 15.1 | 3.7 | 5.6 | 7.1 | calc |
| 1-octanol | | | | | |
| 2,3,3,3-Tetrafluoro-2-(1,1,2,3,3,3- | 13.5 | 3.2 | 4.4 | 25.6 | calc |
| hexafluoro-2- | | | | | |
| (perfluoropropyloxy)propyloxy)- | | | | | |
| 1-propanol | | | | | |

calc: calculated value,
DB: data base value

As the medium (C), the following solvents are preferred, since they have a high affinity with the fluorinated copolymer (A), and they provide a sufficiently high solubility and dispersibility of the fluorinated copolymer (A).

Methyl ethyl ketone, 2-pentanone, methyl isopropyl ketone, 2-hexanone, methyl isobutyl ketone, pinacoline, 2-heptanone, 4-heptanone, diisopropyl ketone, isoamyl methyl ketone, 2-octanone, 2-nonanone, diisobutyl ketone, cyclohexanone, 2-methylcyclohexanone, 3-methylcyclohexanone, 4-ethylcyclohexanone, 2,6-dimethylcyclohexanone, 3,3,5-trimethylcyclohexanone, cycloheptanone, isophorone, (−)-fenchone, propyl formate, isopropyl formate, butyl formate, isobutyl formate, sec-butyl formate, amyl formate, isoamyl formate, hexyl formate, heptyl formate, octyl formate, 2-ethylhexyl formate, ethyl acetate, propyl acetate, isopropyl acetate, butyl acetate, isobutyl acetate, sec-butyl acetate, amyl acetate, isoamyl acetate, hexyl acetate, cyclohexyl acetate, heptyl acetate, 2,2,2-trifluoroethyl acetate, 2,2,3,3-tetrafluoropropyl acetate, 2,2,3,3,3-pentafluoropropyl acetate, 1,1,1,3,3,3-hexafluoro-2-propyl acetate, 2,2-bis(trifluoromethyl)propyl acetate, 2,2,3,3,4,4,4-heptafluorobutyl acetate, 2,2,3,4,4,4-hexafluorobutyl acetate, 2,2,3,3,4,4,5,5,5-nonafluoropentyl acetate, 2,2,3,3,4,4,5,5-octafluoropentyl acetate, 3,3,4,4,5,5,6,6,6-nonafluorohexyl acetate, 4,4,5,5,6,6,7,7,7-nonafluoroheptyl acetate, 2,2,3,3,4,4,5,5,6,6,7,7-dodecafluorohepthyl acetate, methyl propionate, ethyl propionate, propyl propionate, isopropyl propionate, butyl propionate, isobutyl propionate, sec-butyl propionate, t-butyl propionate, amyl propionate, isoamyl propionate, hexyl propionate, cyclohexyl propionate, methyl butyrate, ethyl butyrate, propyl butyrate, isopropyl butyrate, butyl butyrate, isobutyl butyrate, sec-butyl butyrate, t-butyl butyrate, amyl butyrate, isoamyl butyrate, methyl isobutyrate, ethyl isobutyrate, propyl isobutyrate, isopropyl isobutyrate, butyl isobutyrate, isobutyl isobutyrate, sec-butyl isobutyrate, t-butyl isobutyrate, amyl isobutyrate, isoamyl isobutyrate, methyl valerate, ethyl valerate, propyl valerate, isopropyl valerate, butyl valerate, isobutyl valerate, sec-butyl valerate, t-butyl valerate, methyl isovalerate, ethyl isovalerate, propyl isovalerate, isopropyl isovalerate, butyl isovalerate, isobutyl isovalerate, sec-butyl isovalerate, t-butyl isovalerate, methyl hexanoate, ethyl hexanoate, propyl hexanoate, isopropyl hexanoate, methyl heptanoate, ethyl heptanoate, methyl octanoate, methyl cyclohexanecarboxylate, ethyl cyclohexanecarboxylate, 2,2,2-trifluoroethyl cyclohexanecarboxylate, bis(2,2,2-trifluoroethyl)succinate, bis(2,2,2-trifluoroethyl)glutarate, ethyl trifluoroacetate, propyl trifluoroacetate, isopropyl trifluoroacetate, butyl trifluoroacetate, isobutyl trifluoroacetate, sec-butyl trifluoroacetate, t-butyl trifluoroacetate, amyl trifluoroacetate, isoamyl trifluoroacetate, hexyl trifluoroacetate, cyclohexyl trifluoroacetate, heptyl trifluoroacetate, ethyl difluoroacetate, ethyl perfluoropropionate, methyl perfluorobutanoate, ethyl perfluorobutanoate, methyl perfluoropentanoate, ethyl perfluoropentanoate, methyl 2,2,3,3,4,4,5,5-octafluoropentanoate, ethyl 2,2,3,3,4,4,5,5-octafluoropentanoate, methyl perfluoroheptanoate, ethyl perfluoroheptanoate, methyl 2,2,3,3,4,4,5,5,6,6,7,7-dodecafluoroheptanoate, ethyl 2,2,3,3,4,4,5,5,6,6,7,7-dodecafluoroheptanoate, methyl 2-trifluoromethyl-3,3,3-trifluoropropionate, ethyl 2-trifluoromethyl-3,3,3-trifluoropropionate, 2-propxyethyl acetate, 2-butoxyethyl acetate, 2-pentyloxyethyl acetate, 1-methoxy-2-acetoxypropane, 1-ethoxy-2-acetoxypropane, 1-propoxy-2-acetoxypropane, 1-butoxy-2-acetoxypropane, 3-methoxybutyl acetate, 3-ethoxybutyl acetate, 3-propoxybutyl acetate, 3-methoxy-3-methylbutyl acetate, 3-ethoxy-3-methylbutyl acetate, 4-methoxybutyl acetate, 4-ethoxybutyl acetate, 4-propoxybutyl acetate, diethyl carbonate, dipropyl carbonate, dibutyl carbonate, bis(2,2,2-trifluoroethyl)carbonate, bis(2,2,3,3-tetrafluoropropyl)carbonate, tetrahydrofuran, butyronitrile, isobutyronitrile, valeronitrile, isovaleronitrile, capronitrile, isocapronitrile, heptanenitrile, octanenitrile, nonanenitrile, 3-(trifluoromethyl)benzonitrile, methyl pentafluorobenzoate, ethyl pentafluorobenzoate, methyl-3-(trifluoromethyl)benzoate, methyl 4-(trifluoromethyl)benzoate, methyl 3,5-bis(trifluoromethyl)benzoate, 1-(pentafluorophenyl)ethanol, pentafluorophenyl formate, pentafluorophenyl acetate, pentafluorophenyl propanoate, pentafluorophenyl butanoate, pentafluorophenyl pentanoate, 2′,3′,4′,5′,6′-pentafluoroacetophenone, 3′,5′-bis(trifluoromethyl)acetophenone, 3′-(trifluoromethyl)acetophenone, pentafluoroanisole, 3,5-bis(trifluoromethyl)anisole, pentafluoropyridine, 4-chlorobenzotrifluoride, 1,3-bis(trifluoromethyl)benzene, 2,2,2-trifluoroethyl benzoate, 2,2,3,3-tetrafluoropropyl benzoate, 2,2,3,3,3-pentafluoropropyl benzoate, 1,1,1,3,3,3-hexafluoro-2-propyl benzoate, 2,2-bis(trifluoromethyl)propyl benzoate, 2,2,3,3,4,4,4-heptafluorobutyl benzoate, 2,2,3,4,4,4-hexafluorobutyl benzoate, 2,2,3,3,4,4,5,5,5-nonafluoropentyl benzoate, 2,2,3,3,4,4,5,5-octafluoropentyl benzoate, bis(2,2,2-trifluoroethyl)phthalate, 5-(perfluorobutyl)bicyclo[2.2.1]-2-heptene, 5-(perfluorobutyl)bicyclo[2.2.1]heptane, 1,1,2,2,3,3,4-heptafluorocyclopentane, 1,1,1,2,3,3-hexafluoro-4-(1,1,2,3,3,3-hexafluoropropoxy)pentane, 2,2,3,4,4,4-hexafluoro-1-butanol, 2,2,3,3,4,4,5,5-octafluoro-1-pentanol, 2,2-bis(trifluoromethyl)-1-propanol, 3,3,4,4,5,5,6,6,6-nonafluoro-1-hexanol, 2,3,3,3-tetrafluoro-2-(perfluoropropyloxy)-1-propanol, 4,4,5,5,6,6,7,7,7-nonafluoro-1-heptanol, 2,2,3,3,4,4,5,5,6,6,7,7-dodecafluoro-1-heptanol, 3,3,4,4,5,5,6,6,7,7,8,8,8-tridecafluoro-1-octanol, 7,7,8,8,8-pentafluoro-1-octanol, 4,4,5,5,6,6,7,7,8,8,9,9,9-tridecafluoro-1-nonanol, and 7,8,8,8-tetrafluoro-7-(trifluoromethyl)-1-octanol.

As the medium (C), one type may be used alone, or two or more types may be used in combination. Further, a solvent mixture having another solvent mixed to the medium (C) may be used so long as it can be used as a medium (C) after the mixing. Further, a solvent mixture having two or more other solvents mixed to the medium (C) may be used so long as it can be used as a medium (C) after the mixing.

Specifically, the following combinations may be mentioned as solvent mixtures which can be used as the medium (C).

TABLE 8

| Solvents | δd | δp | δh | R | |
|---|---|---|---|---|---|
| Pinacolin | 15.2 | 5.7 | 5.3 | 2.0 | calc |
| Benzonitrile | 18.8 | 12.0 | 3.3 | 79.1 | DB |
| 90/10 (volume ratio) | 15.6 | 6.3 | 5.1 | 1.1 | — |
| t-Butyl formate | 14.8 | 5.4 | 7.4 | 12.9 | calc |
| Acetophenone | 18.8 | 9.0 | 4.0 | 49.4 | DB |
| 71/29 (volume ratio) | 16.0 | 6.4 | 6.4 | 5.3 | — |
| t-Butyl acetate | 15.0 | 3.7 | 6.0 | 8.9 | DB |
| Cyclopentanone | 17.9 | 11.9 | 5.2 | 58.6 | DB |
| 76/24 (volume ratio) | 15.7 | 5.8 | 5.8 | 2.3 | — |
| Benzotrifluoride | 17.5 | 8.8 | 0.0 | 41.1 | DB |
| 1,4-Dioxane | 17.5 | 1.8 | 9.0 | 50.3 | DB |
| 54/46 (volume ratio) | 17.5 | 5.6 | 4.1 | 13.0 | — |
| Cyclohexane | 17.8 | 8.4 | 5.1 | 25.6 | DB |
| Hexafluorobenzene | 16.0 | 0.0 | 0.0 | 51.3 | DB |
| 62/38 (volume ratio) | 17.1 | 5.2 | 3.2 | 9.6 | — |

calc: calculated value,
DB: data base value

As the medium (C), it is preferred to use a solvent, with which a temperature range to exhibit a solution state with the fluorinated copolymer (A) is present at a temperature of not higher than 230° C. When such a temperature range is present at a temperature of not higher than 230° C., the after-described mixing of the fluorinated copolymer (A) and the thermoplastic resin (B) can be carried out at a sufficiently low temperature than the melting point of the fluorinated copolymer (A), whereby it is possible to prevent deterioration of the characteristics of the fluorinated copolymer (A) and the thermoplastic resin (B).

As the medium (C), with which the temperature range to exhibit a solution state with the fluorinated copolymer (A) is present at a temperature of not higher than 230° C., i.e. which has a dissolution temperature of not higher than 230° C., the following solvents may be mentioned.

Diisopropyl ketone (dissolution temperature: 150° C.)

2-Hexanone (dissolution temperature: 150° C.)

Cyclohexanone (dissolution temperature: 180° C.)

3′,5′-bis(trifluoromethyl)acetophenone (dissolution temperature: 150° C.)

2′,3′,4′,5′,6′-Pentafluoroacetophenone (dissolution temperature: 150° C.)

Benzotrifluoride (dissolution temperature: 150° C.)

Isobutyl acetate (dissolution temperature: 150° C.)

Here, the dissolution temperature in brackets ( ) is a dissolution temperature in a case where the fluorinated copolymer (A) is ETFE1 in the following Examples.

The medium (C) is preferably a solvent which is liquid at room temperature (25° C.) from such a viewpoint that a solid content made of a mixture of the fluorinated copolymer (A) and the thermoplastic resin (B) is separated by e.g. re-precipitation from the fluorinated copolymer composition, or the fluorinated copolymer composition is used as a coating composition. Further, for the same reason, the melting point of the medium (C) is preferably at most 20° C. Further, the boiling point (under ordinary pressure) of the medium (C) is preferably at most 230° C., more preferably at most 200° C., from the viewpoint of the handling efficiency of the medium (C) and the solvent removability at the time of separating the solid content from the fluorinated copolymer composition.

### (Preferred Combinations of Fluorinated Copolymer (A), Thermoplastic Resin (B) and Medium (C))

Now, preferred combinations of the fluorinated copolymer (A), the thermoplastic resin (B) and the medium (C) will be described. In the fluorinated copolymer composition of the present invention, it is preferred to select the optimum one among the above described medium solvents (C) depending upon the combination of the fluorinated copolymer (A) and the thermoplastic resin (B). As such a medium (C), one which dissolves the fluorinated copolymer (A) and the thermoplastic resin (B) simultaneously, is preferred, and therefore, the selection can be made as follows.

(1) A case where the value of R based on Hansen solubility parameters of the thermoplastic resin (B) is at least 49.

In a case where ETFE is used as the fluorinated copolymer (A), and polysulfone (PSf) is used as the thermoplastic resin (B), center point P between the coordinates of Hansen solution parameters of polysulfone (δd, δp, δh)=(19.0, 11.0, 8.0, R:85.3) and the coordinates of diisopropyl ketone (15.7, 5.7, 4.3) most suitable as a solvent for ETFE, becomes (17.4, 8.4, 6.2, R:22.5). A solvent which is relatively near from this point P and of which R is less than 49, is selected. In such a case, for example, cyclohexanone ((δd, δp, δh)=(17.8, 8.4, 5.1, R:25.6)) may be mentioned. As such a combination, the following other combinations may be mentioned.

Fluorinated copolymer (A): ETFE

Thermoplastic resin (B): polymethyl methacrylate ((δd, δp, δh)=(18.6, 10.5, 5.1, R:57.3)), coordinates of center point (17.2, 8.1, 4.7, R:14.9)

Medium (C): cyclohexanone ((δd, δp, δh)=(17.8, 8.4, 5.1, R:25.6).

Fluorinated copolymer (A): ETFE

Thermoplastic resin (B): polyvinyl chloride ((δd, δp, δh)=(19.2, 7.9, 3.4, R: 54.7)), coordinates of center point (17.5, 6.8, 3.9))

Medium (C): cyclohexanone ((δd, δp, δh)=(17.8, 8.4, 5.1, R: 25.6).

Fluorinated copolymer (A): ETFE

Thermoplastic resin (B): polyamide 12 ((δd, δp, δh)=(18.5, 8.1, 9.1, R:60.2)), coordinates of center point (17.1, 6.9, 6.7))

Medium (C): cyclohexanone ((δd, δp, δh)=(17.8, 8.4, 5.1, R: 25.6).

Fluorinated copolymer (A): ETFE

Thermoplastic resin (B): polypropylene ((δd, δp, δh)=(18.0, 0, 1.0, R: 64.5)), coordinates of center point (16.9, 2.9, 2.7))

Medium (C): diisopropyl ketone ((δd, δp, δh)=(15.7, 5.7, 4.3, R: 0.0).

(2) A case where the value of R based on Hansen solubility parameters of thermoplastic resin (B) is less than 49.

In a case where a thermoplastic resin (B) having coordinates relatively close to the coordinates of Hansen solubility parameters of the fluorinated copolymer (A), is selected, in the same manner as in the case of (1), a solvent is selected which has coordinates close to the center point between the optimum coordinates as a solvent for the fluorinated copolymer (A) and the coordinates of the thermoplastic resin (B) and of which R is less than 49. Otherwise, it is also possible to simply select a solvent, of which R is rather small. As such a combination, the following combinations may be mentioned.

Fluorinated copolymer (A): ETFE

Thermoplastic resin (B): polyethylene ((δd, δp, δh)=(16.9, 0.8, 2.8, R: 32.0)), coordinates of center point (16.3, 3.3, 3.6, R: 7.7))

Medium (C): diisopropyl ketone ((δd, δp, δh)=(15.7, 5.7, 4.3, R: 0.0).

Fluorinated copolymer (A): ETFE

Thermoplastic resin (B): poly(2,6-dimethyl-1,4-phenylene oxide) ((δd, δp, δh)=(17.9, 3.1, 8.5, R: 43.8)), coordinates of center point (16.8, 4.4, 6.4, R: 10.9)),

Medium (C): diisopropyl ketone ((δd, δp, δh)=(15.7, 5.7, 4.3, R: 0.0)

Fluorinated copolymer (A): ETFE

Thermoplastic resin (B): polyethyl methacrylate ((δd, δp, δh)=(17.6, 9.7, 4.0, R: 30.5)), coordinates of center point (16.7, 7.7, 4.2, R: 8.0)

Medium (C): 2-hexanone ((δd, δp, δh)=(15.3, 6.1, 4.1, R: 0.8). (Mixing of fluorinated copolymer (A) and thermoplastic resin (B))

Mixing of the fluorinated copolymer (A) and the thermoplastic resin (B) is carried out in the medium (C) at a temperature of at least the dissolution temperature at which the fluorinated copolymer (A) dissolves in the medium (C) and not higher than the melting point of the fluorinated copolymer (A).

At the time of mixing, at least the fluorinated copolymer (A) may be in a solution state.

At the time of mixing, the thermoplastic resin (B) may be in a solution state or in a dispersion state. The solution state is preferred from the viewpoint of the miscibility and compatibility with the fluorinated copolymer (A) and the thermoplastic resin (B).

The following methods (α) to (β) may, for example, be mentioned, as the mixing method.

(α) A mixing method wherein the thermoplastic resin (B) is dissolved or dispersed in the medium (C) and then, the fluorinated copolymer (A) is added and dissolved thereto.

(β) A mixing method wherein the fluorinated copolymer (A) is dissolved in the medium (C), and then, the thermoplastic resin (B) is added and dissolved or dispersed therein.

(γ) A mixing method wherein the fluorinated copolymer (A) and the thermoplastic resin (B) are added to the medium (C) to dissolve the fluorinated copolymer (A) and at the same time to dissolve or disperse the thermoplastic resin (B).

(δ) A method of mixing one having the fluorinated copolymer (A) dissolved in a part of the medium (C) and one having the thermoplastic resin (B) dissolved or dispersed in the rest of the medium (C).

The temperature at the time of mixing is preferably at least 0° C. and not higher than the melting point of the fluorinated copolymer (A). The melting point of the fluorinated copolymer (A) (i.e. ETFE) is about 275° C. at the maximum.

The upper limit temperature at the time of mixing is preferably at most 230° C., most preferably at most 200° C., with a view to preventing deterioration of characteristics of the fluorinated copolymer (A) and the thermoplastic resin (B).

In the case of the methods (α), (β) and (γ), the lower limit temperature at the time of mixing is at least the dissolution temperature at which the fluorinated copolymer (A) dissolves in the medium (C), and at least 0° C., more preferably at least 20° C., with a view to obtaining a sufficiently dissolved state. On the other hand, in the case of the method (δ), at the time of mixing one having the fluorinated copolymer (A) dissolved in a part of the medium (C) and then having it precipitated in the form of micro particles in the medium, and one having the thermoplastic resin (B) dissolved or dispersed in the rest of the medium (C), it is not necessarily required to re-dissolve the fluorinated copolymer (A) and the thermoplastic resin (B) in the medium (C).

In a case where heating is required, mixing of the respective components and heating may be carried out simultaneously, or the respective components may be mixed and then heating may be carried out with stirring as the case requires.

The pressure at the time of mixing is usually preferably ordinary pressure or a slightly exerted pressure at a level of 0.5 MPa. In a case where the temperature at the time of mixing is higher than the boiling point of the medium (C), mixing may be carried out in a pressure resistant container at least under naturally occurring pressure, preferably at most 3 MPa, more preferably at most 2 MPa, further preferably at most 1 MPa, most preferably at most ordinary pressure, and the pressure is usually at a level of from 0.01 to 1 MPa.

The mixing time depends on e.g. the mixing ratio of the fluorinated copolymer (A) and the thermoplastic resin (B), the shapes of the fluorinated copolymer (A) and the thermoplastic resin (B) before adding to the medium (C), etc. The shapes of the fluorinated copolymer (A) and the thermoplastic resin (B) are preferably in a powder form with a view to shortening the dissolving time in the medium (C) and preferably in a pellet form from the viewpoint of availability.

As a mixing means, a known stirring/mixing machine may be used, such as a homomixer, a Henschel mixer, a Banbury mixer, a pressure kneader or a single screw or twin screw extruder.

In a case where mixing is carried out under pressure, an apparatus such as a autoclave equipped with a stirrer may be used. A stirring vane may, for example, be a marine propeller vane, an paddle vane, an anchor vane, a turbine vane or the like. In a case where mixing is carried out in a small scale, a magnetic stirrer or the like may be used.

The mixing ratio of the fluorinated copolymer (A) to the thermoplastic resin (B) may suitably be determined depending upon the particular application of the obtainable fluorinated copolymer composition and is not particularly limited. The mass ratio of the fluorinated copolymer (A) to the thermoplastic resin (B) i.e. (A)/(B) is preferably from 99/1 to 1/99, more preferably from 95/5 to 5/95.

The proportion of the medium (C) is preferably from 5 to 99.9 mass %, more preferably from 10 to 99 mass %, based on 100 mass % of the fluorinated copolymer composition. Within this range, it is easy to separate the solid content made of a mixture of the fluorinated copolymer (A) and the thermoplastic resin (B) from the fluorinated copolymer composition by e.g. re-precipitation, or to use the fluorinated copolymer composition as a coating composition. When the proportion of the medium (C) is within such a range, removable of the medium (C) is easy at the time of separating the solid content from the fluorinated copolymer composition. Further, it will be excellent in the handling efficiency as a coating composition, and the obtainable coating film can be made to be homogeneous.

The fluorinated copolymer composition obtained by the process of the present invention may contain a medium other than the above medium (C) or various additives as described hereinafter, as the case requires, but it is preferably a composition consisting of the fluorinated copolymer (A), the thermoplastic resin (B) and the medium (C).

### (Precipitation of Micro Particles)

By holding the fluorinated copolymer composition obtained by the method of the present invention under such a condition that the fluorinated copolymer (A) and/or the thermoplastic resin (B) precipitates in the medium (C) (usually under ordinary temperature/ordinary pressure condition), the fluorinated copolymer (A) and/or the thermoplastic resin (B) precipitates alone or as a mixture, in the medium (C), whereby a slurry (dispersion) is obtainable.

Further, depending upon the types of the fluorinated copolymer (A), the thermoplastic resin (B) and the medium (C), micro particles of the fluorinated copolymer (A) will precipitate in the medium (C), whereby a slurry will be obtained. At that time, the thermoplastic resin (B) will be in a state as dissolved or dispersed in the medium (C).

Specifically, in a case where the method of the present invention is carried out under heating, the obtained solution is cooled to a temperature of at most the temperature for precipitation of the fluorinated copolymer (A) and the thermoplastic resin (B) or for precipitation of the fluorinated copolymer (A), so that micro particles of the mixture or the fluorinated copolymer (A) are precipitated in the medium (C). The cooling method may be annealing or quenching.

As the state in the vicinity of room temperature of the fluorinated copolymer composition obtained by the method of the present invention, specifically, the following states (I) to (V) may be mentioned.

In a case where the dissolution temperature of the fluorinated copolymer (A) in the medium (C) is higher than room temperature:

(I) A slurry state wherein micro particles of a uniform mixture of the fluorinated copolymer (A) and the thermoplastic resin (B) are precipitated in the medium (C).

(II) A slurry state wherein micro particles of the fluorinated copolymer (A) are precipitated in the medium (C), and the thermoplastic resin (B) is dissolved in the medium (C).

(III) A slurry state wherein core/shell micro particles having the fluorinated copolymer (A) precipitated on the surface of micro particles of the thermoplastic resin (B), are precipitated in the medium (C).

In a case where the dissolution temperature of the fluorinated copolymer (A) in the medium (C) is lower than room temperature:

(IV) A slurry state wherein micro particles of the thermoplastic resin (B) are dispersed in the medium (C), and the fluorinated copolymer (A) is dissolved in the medium (C).

(V) A solution state wherein the fluorinated copolymer (A) and the thermoplastic resin (B) are dissolved in the medium (C).

### (Advantageous Effects)

In the above described method for producing a fluorinated copolymer composition of the present invention, the fluorinated copolymer (A) and the thermoplastic resin (B) are mixed in the medium (C) at a temperature of at least the dissolution temperature at which the fluorinated copolymer (A) dissolves in the medium (C) and not higher than the melting point of the fluorinated copolymer (A).

In a case where the thermoplastic resin (B) also dissolves in the medium (C), it is possible to obtain a solution or micro particles of a mixture having the fluorinated copolymer (A) and the thermoplastic resin (B) uniformly mixed.

In a case where the thermoplastic resin (B) does not dissolve in the medium (C), it is possible to obtain a dispersion having micro particles of the thermoplastic resin (B) uniformly dispersed in a solution of the fluorinated copolymer (A), or core/shell micro particles having the fluorinated copolymer (A) precipitated on the surface of micro particles of the thermoplastic resin (B).

Thus, according to the method for producing the fluorinated copolymer composition of the present invention, the fluorinated copolymer (A) and the thermoplastic resin (B) can be uniformly mixed at a relatively low temperature.

### <Coating Composition>

The coating composition of the present invention is one comprising the fluorinated copolymer composition obtained by the method of the present invention and, as the case requires, various additives.

The state of the coating composition of the present invention may be any one of the above described states (I) to (V).

Further, the content of the fluorinated copolymer (A) in the coating composition of the present invention may be changed suitably depending upon the thickness of the desired coating film. From the viewpoint of the forming properties of the coating film, the proportion of the fluorinated copolymer (A) is preferably from 0.05 to 50 mass %, more preferably from 0.1 to 30 mass %, based on the coating composition (100 mass %). If the content is within this range, it is possible to form a homogeneous coating film excellent in handling efficiency such as the viscosity, drying speed, uniformity of the film, etc.

### (Additives)

Additives may, for example, be an antioxidant, a photostabilizer, an ultraviolet absorber, a crosslinking agent, a lubricant, a plasticizer, a thickening agent, a dispersion stabilizer, a bulking agent (filler), a reinforcing agent, a pigment, a dye, a flame retardant, an antistatic agent, etc.

The proportion of the total of additives is preferably at most 30 mass % based on the coating composition (100 mass %).

Additives may be added in the process for mixing the fluorinated copolymer (A) and the thermoplastic resin (B) in the medium (C), and therefore, as compared with a case of adding in a process for melt kneading, etc., such additives can be added in a large amount and uniformly. Further, by using the coating composition containing additives in a high concentration, the necessary functions can be obtained by a relatively thinner coating film, whereby the proportions of the fluorinated copolymer (A) and the thermoplastic resin (B) can be made smaller.

### (Uses)

As uses of the coating composition of the present invention, the following uses may be mentioned.

Optical field: clad material for optical fibers, lenses, etc., protective coating agents, antifouling coating agents, low reflection coating agents, etc. for various optical films

Solar cell field: protective covering material, transparent conductive components, protective coating agents for backsheet, etc., gas barrier layers, support resin layers for thin plate glass, adhesive layers, etc.

Display panel/display field: protective coating agents, antifouling coating agents or low reflection coating agents for transparent components to be used for various display panels (liquid crystal display panels, plasma display panels, electrochromic display panels, electroluminescence display panels, touch panels); support resins for thin plate glass, etc.

Electric/electronic field: protective coating agents, water repellent coating agents or low reflection coating agents for various electric/electronic components such as optical disks, liquid crystal cells, printed circuit boards, photosensitive drums; interlayer insulation films or protective films in semiconductor elements or integrated circuit devices; solder masks, solder resists, IC sealing agents, electrically insulating covering material, etc.

Transport equipment field: protective coating agents, antifouling coating agents or low reflection coating agents for various components (exterior components such as surface material for display equipments, etc., interior components such as surface material for instrument panels, etc., laminate material for safety glass, etc.)

Building field: protective coating agents, antifouling coating agents or low reflection coating agents for mirrors, glass windows, resin windows, etc.; sealant portions for building components, antifouling coating agents for sealants, etc.

Separation membrane field: adhesives or antifouling coating agents in the production of membrane modules; functional layers for reverse osmosis membranes, nanofiltration membranes, etc.; functional layers for gas separation membranes to separate carbon dioxide, hydrogen, etc.; protective coating agents, antifouling coating agents, etc. for filtration cloth for bag filters.

Others: protective coating agents for rubbers and plastics, weather resistant/antifouling coating agents; protective coating agents for fibers and cloth; corrosion-preventive coating materials, resin-attachment preventive agents; ink-attachment preventive agents, primers for laminate steel plates, various adhesives, binders, etc.

Especially when the coating composition of the present invention is used as an interlayer insulating film or protective film in a semiconductor element or integrated circuit device, it is possible to obtain a semiconductor element or integrated circuit device having a high response speed with little malfunction, utilizing the characteristics of the fluorinated copolymer (A) such as the low water absorbing property, low dielectric constant and high heat resistance.

Further, when the coating composition of the present invention is used as a protective coating agent or an antifouling coating agent for a light-collecting mirror to be used for light-collecting type solar heat cover generation or as a protective coating agent for a sealing portion such as a backing resin for a light-collecting mirror, it is possible to obtain a power generation system which is highly durable without requiring maintenance, by virtue of the characteristics of the fluorinated copolymer (A) such as high heat resistance and low water absorbing property.

### (Advantageous Effects)

The above described coating composition of the present invention comprises the fluorinated copolymer composition having the fluorinated copolymer (A) and the thermoplastic resin (B) uniformly mixed, as obtained by the method of the present invention, whereby it is possible to form a coating film provided with characteristics of both the fluorinated copolymer (A) and the thermoplastic resin (B).

### <Article Having Coating Film>

The article having a coating film of the present invention is one having, on the surface of a substrate, a coating film formed by using the coating composition of the present invention. The coating film may be used as a film by separating it from the substrate.

### (Coating Film)

The coating film or film formed by using the coating composition of the present invention is thin and uniform as compared with an ETFE film obtainable by melt forming. The thickness of the coating film or film may suitably be determined depending upon the particular use. By using a coating composition having a high solid content concentration, it is possible to obtain a thick coating film, and by using a coating composition having a low solid content concentration, it is possible to obtain a thin coating film. Further, by repeating such coating in a plurality of times, it is also possible to obtain a thicker coating film.

### (Substrate)

The material for the substrate may, for example, be a metal (such as iron, stainless steel, aluminum, titanium, copper or silver), a glass (such as soda lime glass, silicate glass or synthetic quartz), silicon, an organic material (such as polycarbonate (PC), polyethylene terephthalate (PET), polymethyl methacrylate (PMMA), glass fiber reinforced plastic (FRP), or polyvinyl chloride (PVC)), stone material, wood material, ceramics, cloth, paper, etc.

The shape of the substrate is not particularly limited.

To the substrate, pretreatment may be applied for the purpose of e.g. improvement of the adhesion between the substrate and the coating film. The method for pretreatment may, for example, be a method of applying a silane coupling agent, a polyethyleneimine or the like to the substrate, a method of physically treating the surface by e.g. sand blasting, or a method of treating the substrate by e.g. corona discharge.

### (Method for Forming Coating Film)

As a method for forming a coating film, a method may be mentioned wherein the coating composition of the present invention is applied to a substrate to form a wet film, and the medium (C) is removed from the wet film to form a coating film.

The coating method may, for example, be gravure coating, dip coating, die coating, electrostatic coating, brush coating, screen printing, roll coating or spin coating.

When applied to the substrate, the state of the coating composition of the present invention may be any one of the above-described states (I) to (V). Even in a slurry state, the respective micro particles are in a state uniformly dispersed in the medium (C), and accordingly, the coating composition in a slurry state can be applied to the substrate at a temperature of less than the dissolution temperature for dissolving the fluorinated copolymer (A) in the medium (C), and the medium (C) can be removed as a relatively low drying temperature. By adjusting the application temperature and drying temperature to be relatively low temperatures, the working efficiency can be improved, and it is possible to obtain a dense and flat coating film.

The application temperature is preferably from 0 to 210° C., more preferably from 0 to 130° C., further preferably from 0 to 50° C., although it may depend also on the composition of the coating composition. When the application temperature is at least 0° C., the dispersion state of the fluorinated copolymer (A) will be sufficient. When the application temperature is at most 210° C., the medium (C) will not rapidly evaporate, whereby formation of air bubbles, etc. can be prevented.

The temperature for removal of the medium (C) i.e. the drying temperature, is preferably from 0 to 350° C., more preferably from 0 to 270° C., further preferably from 0 to 200° C. When the drying temperature is at least 0° C., it does not take too much time for the removal of the solvent. When the drying temperature is at most 350° C., occurrence of coloration, decomposition, etc. can be prevented. Further, by adjusting the drying temperature to at least in the vicinity of the melting point of the fluorinated copolymer (A) and/or the thermoplastic resin (B), the denseness of the coating film will be improved, although it may also depends on the composition of the coating composition.

### (Uses)

As uses of the article having a coating film, the following uses may be mentioned.

Optical field: optical fibers, lenses, optical disks, various optical films, etc.

Solar cell field: light-collecting mirrors, protective covering material constituted by glass or resin, transparent conductive components, etc.

Display panel/display field: transparent components (glass substrates and resin substrates) to be used for various display panels, etc.

Electrical/electronic field: various electrical and electronical components, semiconductor elements, hybrid IC, printed circuit boards, photosensitive drums, film condensers, electric wires and cables, etc.

Transport equipment field: various components for electric cars, buses, trucks, automobiles, ships, aircrafts, etc.

Building field: mirrors, glass windows, resin windows, outer walls, roof materials, bridges, tunnels, etc.

Medical field: syringes, pipettes, thermometers, etc.

Chemical field: beakers, petri dishes, measuring cylinders, etc.

Separation membrane field: reverse osmosis membranes, nanofiltration membranes, gas separation membranes, bag filters, etc.

### (Advantageous Effects)

The above-described article having a coating film of the present invention is one having a coating film formed by using the coating composition of the present invention, whereby it is possible to form a coating film provided with characteristics of both the fluorinated copolymer (A) and the thermoplastic resin (B).

Further, by using the coating composition of the present invention, it is not required to carry out the application or drying at a high temperature, whereby a coating film can be formed without causing decomposition or deformation of the substrate even with a material having a low heat resistance, such as plastic, paper or cloth.

### <Molded Product>

The molded product of the present invention is a molded product comprising the fluorinated copolymer (A) and the thermoplastic resin (B), obtained by using a fluorinated copolymer composition obtained by the method of the present invention.

The molded product is usually produced by molding a solid content composed of a mixture of the fluorinated copolymer (A) and the thermoplastic resin (B), separated from the fluorinated copolymer composition.

The method for separating the solid content may be a method of filtering the fluorinated copolymer composition in a slurry state. As such a filtration method, a known method may be mentioned.

In a case where the fluorinated copolymer composition is in a solution state (or in a state where a solution state and a slurry state are mixed), a solvent having a low affinity (hereinafter referred to as a poor solvent) to the fluorinated copolymer (A) and the thermoplastic resin (B) may be added to make precipitation complete. As such a poor solvent, hexane, methanol or the like may be mentioned.

The separated solid content is preferably dried to remove the medium (C) and the poor solvent. As the drying means, a drying oven may, for example, be mentioned.

The molding method may be a known method.

Uses of the molded product may be the same as the uses of the article having a coating film.

### (Advantageous Effects)

The above-described molded product of the present invention is one obtained by using the coating composition of the present invention, whereby it is possible to form a coating film provided with characteristics of both the fluorinated copolymer (A) and the thermoplastic resin (B).

### EXAMPLES

Now, the present invention will be described in further detail with reference to Examples, but it should be understood that the present invention is by no means limited to such Examples.

Examples 1 to 35 are working examples of the present invention, and Examples 36 to 40 are comparative examples.

### (Mixing of Fluorinated Copolymer (A) and Thermoplastic Resin (B))

In Examples, mixing of the fluorinated copolymer (A) and the thermoplastic resin (B) in the medium (C) was carried out as follows, unless otherwise specified.

As a reactor, a pressure resistant reactor made of borosilicate glass having a thickness of 4.5 mm and an outer diameter of 35 mm, was used. A stirrer was put in the reactor, and the content was thoroughly stirred.

The reactor was heated by means of an oil bath, heat block, mantle heater or microwave heating device, having the temperature controlled.

The concentration of a solid content of the content (the sum of the fluorinated copolymer (A) and the thermoplastic resin (B)) in the reactor was set to be from 1 to 5 mass %.

Whether or not the fluorinated copolymer (A) and the thermoplastic resin (B) were dissolved in the medium (C) and became in a solution state, was visually observed, and when the content in the reactor became a uniform transparent solution, such a state was judged to be a solution state.

### (Hot Press Forming)

Preparation of a pressed film was carried out by means of a hot press machine (SA-301), manufactured by TESTER SANGYO CO., LTD.).

### (Tensile Test)

From a pressed film formed by the hot press machine, a dumbbell-shaped test piece (length: 45 mm, length of parallel portions: 22 mm, width: 5 mm, thickness: about 100 μm) was prepared. Using Tensilon RTC-1210 manufactured by ORIENTEC Co., LTD., the yield point stress and the elongation at breakage were measured under the following conditions.

Distance between clamps: 22 mm

Tension rate: 10 mm/min

Temperature: 25° C.

Relative humidity: 50%

Other conditions: in accordance with JIS K7113 (tensile test method for plastics)

### (Thickness)

With respect to a pressed film formed by the hot press machine and a coating film obtained by potting, the thickness was measured by means of a stylus profilometer (DEKTAK 3ST, manufactured by Sloan).

With respect to a coating film obtained by a method other than potting, the thickness was measured by means of a non-contact optical thin film measuring apparatus (Filmetrics F-20, manufactured by Filmetrics Japan, Inc.).

### (Surface Hardness)

The surface hardness was measured in accordance with the pencil hardness test (JIS K5600).

### (Fluorinated Copolymer (A))

ETFE1 and ETFE4 were produced by the method disclosed in Japanese Patent No. 3,272,474 or W02006/134764.

ETFE1: ratio (molar ratio) of repeating units:
TFE/ethylene/hexafluoropropylene/3,3,4,4,5,5,6,6,6-nonafluoro-1-hexene/itaconic anhydride=47.7/42.5/8.4/1.2/0.2, melting point: 188° C.

ETFE2: Fluon (registered trademark) LM-720AP, manufactured by Asahi Glass Company, Limited, melting point: 225° C.

ETFE3: Fluon (registered trademark) Z-8820X, manufactured by Asahi Glass Company, Limited, melting point: 260° C.

ETFE4: ratio (molar ratio) of repeating units:
TFE/ethylene/hexafluoropropylene/3,3,4,4,5,5,6,6,6-nonafluoro-1-hexene/itaconic anhydride=44.6/45.6/8.1/1.3/0.4, melting point: 192° C.

### (Thermoplastic Resin (B))

PE: low density polyethylene (catalogue No.: 428043, manufactured by Aldrich)

PP: polypropylene (catalogue No.: 182389, manufactured by Aldrich, weight average molecular weight: 250,000)

EEA: ethylene/ethyl acrylate copolymer (catalogue No.: 200581, manufactured by Aldrich, ethyl acrylate: 18 mass %)

EVA: ethylene/vinyl acetate copolymer (catalogue No.: 437247, manufactured by Aldrich, vinyl acetate: 12 mass %)

EAA: ethylene/acrylic acid copolymer (catalogue No.: 426717, manufactured by Aldrich, acrylic acid: 5 mass %)

P (E-graft-MA): ethylene/maleic anhydride copolymer (catalogue No.: 456632, manufactured by Aldrich, maleic anhydride: 3 mass %)

PC3FMA: poly(2,2,3,3,3-pentafluoropropyl methacrylate) (catalogue No.: 592080, manufactured by Aldrich)

PPO: poly(2,6-dimethyl-1,4-phenylene oxide) (catalogue No.: 181781, manufactured by Aldrich)

PVDF: polyvinylidene fluoride (catalogue No.: 427144, manufactured by Aldrich)

PMP: poly(4-methyl-1-pentene) (catalogue No.: 440043, manufactured by Aldrich)

PMMA: polymethyl methacrylate (catalogue No.: 182230, manufactured by Aldrich)

PBT: polybutylene terephthalate (catalogue No.: 190942, manufactured by Aldrich)

PVC: polyvinyl chloride (catalogue No.: 81388, manufactured by Aldrich)

PA12: polyamide 12 (catalogue No.: 181161, manufactured by Aldrich)

ABS: acrylonitrile/butadiene/styrene copolymer (catalogue No. 430129, manufactured by Aldrich)

P (VDC-VC): vinylidene chloride/vinyl chloride copolymer (catalogue No.: 437407, manufactured by Aldrich)

MS: maleic anhydride/styrene copolymer (catalogue No.: 462896, manufactured by Aldrich)

PSf: polysulfone (UDEL P-3500, manufactured by Solvay Advanced Polymers)

AFLAS: tetrafluoroethylene/propylene copolymer (AFLAS (registered trademark) 150E, manufactured by Asahi Glass Company, Limited)

P (MMA-BMA): methyl methacrylate/butyl methacrylate copolymer (catalogue No.: 474029, manufactured by Aldrich, weight average molecular weight: 75,000)

PIBMA: polyisobutyl methacrylate (catalogue No. 445754, manufactured by Aldrich, weight average molecular weight: 130,000)

PEMA: polyethyl methacrylate (catalogue No.: 182087, manufactured by Aldrich, weight average molecular weight: 520,000)

PBMA: polybutyl methacrylate (catalogue No.: 181528, manufactured by Aldrich, weight average molecular weight: 340,000)

PS: polystyrene (catalogue No.: 182427, manufactured by Aldrich, weight average molecular weight: 280,000)

LF916F: trichlorofluoroethylene/vinyl ether copolymer (LUMIFLON (registered trademark) LF916F, manufactured by Asahi Glass Company, Limited)

### Example 1

Into a 100 mL reactor, 0.80 g of PE and 78.4 g of diisopropyl ketone were introduced and heated to 150° C. with stirring under a closed condition to obtain a uniform transparent solution. The solution was once cooled to room temperature with stirring to obtain a white-colored slurry. To such a slurry, 0.80 g of ETFE1 was introduced, followed by heating to 150° C. with stirring to obtain a uniform transparent solution. The reactor was dipped in a methanol solution of dry ice to cool the solution to room temperature, whereby a mixture of PE and ETFE1 precipitated, and a white-colored slurry was obtained. To such a slurry, 100 g of hexane was added, followed by stirring for 15 minutes. After filtration, drying under reduced pressure was carried out at 70° C. for 15 hours to obtain 1.44 g of a mixture of PE and ETFE1. The results are shown in Tale 9.

### Examples 2 to 24

A mixture of the fluorinated copolymer (A) and the thermoplastic resin (B) was obtained in the same manner as in Example 1 except that the blend was changed as shown in Table 9. The results are shown in Table 9.

### Example 25

1.74 g of a mixture of PP and ETFE1 was obtained in the same manner as in Example 1 except that the blend was changed as shown in Table 9.

By means of a hot press machine, the mixture was subjected to hot press forming under such conditions that the temperature was 205° C., the pressure was 10 Ma and the time was 5 minutes to obtain a pressed film. The evaluation results are shown in Table 10.

### Example 26

Into a 100 mL reactor, 1.60 g of P (MMA-BMA), 2.40 g of ETFE1 and 76.0 g of diisopropyl ketone were introduced and heated to 150° C. with stirring to obtain a uniform transparent solution. The reactor was dipped in a methanol solution of dry ice to cool the solution to room temperature, whereby a uniform micro particle dispersion containing a mixture of P (MMA-BMA) and ETFE1 free from sedimentation was obtained. The dispersion was added to 100 g of hexane, followed by stirring for 15 minutes. Precipitated white precipitate was collected by filtration, followed by drying under reduced pressure at 70° C. for 15 hours to obtain 3.76 g of a mixture of P (MMA-BMA) and ETFE1.

By means of a hot press machine, the mixture was subjected to hot press forming under such conditions that the temperature was 230° C., the pressure was 10 Ma and the time was 5 minutes, to obtain a pressed film. The evaluation results are shown in Table 10.

### Example 27

3.92 g of a mixture of PPO and ETFE1 was obtained in the same manner as in Example 1 except that the blend was changed as shown in Table 9.

By means of a hot press machine, the mixture was subjected to hot press forming under such conditions that the temperature was 190° C., the pressure was 10 Ma and the time was 5 minutes to obtain a pressed film. The evaluation results are shown in Table 10.

### Example 28

4.66 g of a mixture of PIBMA and ETFE1 was obtained in the same manner as in Example 10 except that 0.3 g of PIBMA, 4.50 g of ETFE1 and 75.2 g of diisopropyl ketone were used and dissolved at 140° C., and methanol was used for re-precipitation.

By means of a hot press machine, the mixture was subjected to hot press forming under such conditions that the temperature was 170° C., the pressure was 10 Ma and the time was 5 minutes, to obtain a pressed film, whereby a transparent film was obtained.

### Example 29

Into a 20 mL reactor, 0.16 g of PIBMA, 0.16 g of ETFE4 and 15.7 g of 2-hexanone were introduced and heated to 150° C. with stirring under a closed condition, to obtain a uniform transparent solution. The reactor was gradually cooled to room temperature to obtain a uniform micro particle dispersion containing a mixture of ETFE4 and PIBMA free from sedimentation. The dispersion was applied to a glass substrate at room temperature by potting and air-dried, followed by drying by heating on a hot plate at 100° C. for 3 minutes to obtain a glass substrate having a coating film of a mixture of ETFE4 and PIBMA formed on its surface. The evaluation results are shown in Table 10.

### Examples 30 to 35

A glass substrate having a coating film formed on its surface was obtained in the same manner as in Example 29 except that the blend was changed as shown in Table 9. The evaluation results are shown in Table 10.

### Example 36

By means of a hot press machine, ETFE1 was subjected to hot press forming under such conditions that the temperature was 230° C., the pressure was 10 Ma and the time was 5 minutes, to obtain a pressed film. The evaluation results are shown in Table 10.

### Example 37

By means of a hot press machine, PP was subjected to hot press forming under such conditions that the temperature was 200° C., the pressure was 10 Ma and the time was 5 minutes, to obtain a pressed film. The evaluation results are shown in Table 10.

### Example 38

By means of a hot press machine, P (MMA-BMA) was subjected to hot press forming under such conditions that the temperature was 230° C., the pressure was 10 Ma and the time was 5 minutes, to obtain a pressed film. The evaluation results are shown in Table 10.

### Example 39

By means of a hot press machine, ETFE1 was subjected to hot press forming under such conditions that the temperature was 170° C., the pressure was 10 Ma and the time was 5 minutes, to obtain a pressed film. A very brittle non-uniform film was obtained.

### Example 40

A glass substrate having a coating film of ETFE4 formed on its surface was obtained in the same manner as in Example 23 except that 0.32 g of ETFE4 was used without using the thermoplastic resin (B). The evaluation results are shown in Table 10.

TABLE 9

| | | | | | | | | Solid content | Dissolution | |
|---|---|---|---|---|---|---|---|---|---|---|
| | (A) | | (B) | | (C) | | | concentration | temperature | Yield |
| Ex. | Type | (g) | Type | (g) | Compound name | R | (g) | (mass %) | (° C.) | (g) |
| 1 | ETFE1 | 0.80 | PE | 0.80 | Diisopropyl ketone | 0 | 78.4 | 2 | 150 | 1.44 |
| 2 | ETFE1 | 0.80 | PP | 0.80 | Diisopropyl ketone | 0 | 78.4 | 2 | 150 | 1.49 |
| 3 | ETFE1 | 0.80 | EEA | 0.80 | Diisopropyl ketone | 0 | 78.4 | 2 | 150 | 1.50 |
| 4 | ETFE1 | 0.80 | EVA | 0.80 | Diisopropyl ketone | 0 | 78.4 | 2 | 150 | 1.36 |
| 5 | ETFE1 | 0.80 | EAA | 0.80 | Diisopropyl ketone | 0 | 78.4 | 2 | 150 | 1.41 |
| 6 | ETFE1 | 0.80 | P(E-graft-MA) | 0.80 | Diisopropyl ketone | 0 | 78.4 | 2 | 150 | 1.55 |
| 7 | ETFE1 | 0.80 | PC3FMA | 0.80 | Diisopropyl ketone | 0 | 78.4 | 2 | 150 | 1.44 |
| 8 | ETFE1 | 0.80 | PPO | 0.80 | Diisopropyl ketone | 0 | 78.4 | 2 | 160 | 1.48 |
| 9 | ETFE1 | 1.60 | PVDF | 1.60 | Diisopropyl ketone | 0 | 76.8 | 4 | 150 | 2.88 |
| 10 | ETFE1 | 0.80 | PMP | 0.80 | 2-Hexanone | 0.8 | 78.4 | 2 | 150 | 1.57 |
| 11 | ETFE1 | 0.90 | PBT | 0.90 | Cyclohexanone | 25.6 | 88.2 | 2 | 180 | 1.74 |
| 12 | ETFE1 | 0.90 | PMMA | 0.90 | Cyclohexanone | 25.6 | 88.2 | 2 | 180 | 1.68 |
| 13 | ETFE1 | 0.90 | PVC | 0.90 | Cyclohexanone | 25.6 | 88.2 | 2 | 180 | 1.72 |
| 14 | ETFE1 | 0.90 | PA12 | 0.90 | Cyclohexanone | 25.6 | 88.2 | 2 | 180 | 1.61 |
| 15 | ETFE1 | 0.90 | ABS | 0.90 | Cyclohexanone | 25.6 | 88.2 | 2 | 180 | 1.56 |
| 16 | ETFE1 | 0.90 | P(VDC-VC) | 0.90 | Cyclohexanone | 25.6 | 88.2 | 2 | 180 | 1.73 |
| 17 | ETFE1 | 0.90 | MS | 0.90 | Cyclohexanone | 25.6 | 88.2 | 2 | 180 | 1.69 |
| 18 | ETFE1 | 0.90 | PSf | 0.90 | Cyclohexanone | 25.6 | 88.2 | 2 | 180 | 1.60 |
| 19 | ETFE1 | 0.80 | AFLAS | 0.80 | Diisopropyl ketone | 0 | 78.4 | 2 | 150 | 1.52 |
| 20 | ETFE1 | 1.42 | P(MMA-BMA) | 1.42 | 3′,5′-bis(trifluoromethyl)acetophenone | 28.1 | 139.2 | 2 | 150 | 2.61 |
| 21 | ETFE1 | 1.51 | P(MMA-BMA) | 1.51 | 2′,3′,4′,5′,6′- | 34.4 | 148.0 | 2 | 150 | 2.75 |
| | | | | | pentafluoroacetophenone | | | | | |
| 22 | ETFE1 | 1.19 | P(MMA-BMA) | 1.19 | Benzotrifluoride | 41.1 | 116.6 | 2 | 150 | 2.28 |
| 23 | ETFE2 | 0.90 | P(MMA-BMA) | 0.90 | Cyclohexanone | 25.6 | 88.2 | 2 | 180 | 1.70 |
| 24 | ETFE3 | 0.90 | P(MMA-BMA) | 0.90 | Cyclohexanone | 25.6 | 88.2 | 2 | 200 | 1.73 |
| 25 | ETFE1 | 0.90 | PP | 0.90 | Isobutyl acetate | 9.4 | 88.2 | 2 | 150 | 1.74 |
| 26 | ETFE1 | 2.40 | P(MMA-BMA) | 1.60 | Diisopropyl ketone | 0 | 76.0 | 5 | 150 | 3.76 |
| 27 | ETFE1 | 4.00 | PPO | 0.13 | Diisopropyl ketone/ | 0.1 | 78.5 | 5 | 150 | 3.92 |
| | | | | | cyclohexanone | | | | | |
| 28 | ETFE1 | 4.50 | PIBMA | 0.30 | Diisopropyl ketone | 0 | 75.2 | 6 | 140 | 4.66 |
| 29 | ETFE4 | 0.16 | PIBMA | 0.16 | 2-Hexanone | 0.8 | 15.7 | 2 | 150 | — |
| 30 | ETFE4 | 0.16 | PEMA | 0.16 | 2-Hexanone | 0.8 | 15.7 | 2 | 150 | — |
| 31 | ETFE4 | 0.16 | PBMA | 0.16 | 2-Hexanone | 0.8 | 15.7 | 2 | 150 | — |
| 32 | ETFE4 | 0.16 | P(MMA-BMA) | 0.16 | 2-Hexanone | 0.8 | 15.7 | 2 | 150 | — |
| 33 | ETFE4 | 0.16 | PS | 0.16 | 2-Hexanone | 0.8 | 15.7 | 2 | 150 | — |
| 34 | ETFE4 | 0.16 | MS | 0.16 | 2-Hexanone | 0.8 | 15.7 | 2 | 150 | — |
| 35 | ETFE4 | 0.16 | LF916F | 0.16 | 2-Hexanone | 0.8 | 15.7 | 2 | 150 | — |

TABLE 10

| | | | Yield | Elongation | | Surface |
|---|---|---|---|---|---|---|
| | | | point | at | | hardness |
| | | | stress | breakage | Thickness | (pencil |
| | (A) | (B) | (MPa) | (%) | (μm) | hardness) |
| Ex. 25 | ETFE1 | PP | — | — | 100 | B |
| Ex. 26 | ETFE1 | P | 28.2 | 10 | 88 | B |
| | | (MMA- | | | | |
| | | BMA) | | | | |
| Ex. 27 | ETFE1 | PPO | 17.3 | 799 | 110 | 7B |
| Ex. 29 | ETFE4 | PIBMA | — | — | 3 | F |
| Ex. 30 | ETFE4 | PEMA | — | — | 2 | F |
| Ex. 31 | ETFE4 | PBMA | — | — | 3 | B |
| Ex. 32 | ETFE4 | P | — | — | 3 | 2H |
| | | (MMA- | | | | |
| | | BMA) | | | | |
| Ex. 33 | ETFE4 | PS | — | — | 3 | B |
| Ex. 34 | ETFE4 | MS | — | — | 3 | H |
| Ex. 35 | ETFE4 | LF916F | — | — | 2 | 6B |
| Ex. 36 | ETFE1 | — | 15.7 | 417 | 121 | 7B |
| Ex. 37 | — | PP | — | — | 135 | HB |
| Ex. 38 | — | P | — | — | 89 | 4H |
| | | (MMA- | | | | |
| | | BMA) | | | | |
| Ex. 40 | ETFE4 | — | — | — | 3 | 7B |

### INDUSTRIAL APPLICABILITY

The coating composition of the present invention is useful for applications to e.g. surface treatment requiring heat resistance, flame retardancy, chemical resistance, weather resistance, low frictional properties, low dielectric properties, transparency, etc., since it is possible to easily form a coating film comprising a fluorinated copolymer (ETFE) having repeating units derived from ethylene and repeating units derived from TFE, and other resin.

This application is a continuation of PCT Application No. PCT/JP2011/059301 filed on Apr. 14, 2011, which is based upon and claims the benefit of priority from Japanese Patent Application No. 2010-094981 filed on Apr. 16, 2010. The contents of those applications are incorporated herein by reference in its entirety.

What is claimed is:

1. A method for producing a fluorinated copolymer composition comprising a fluorinated copolymer (A) having repeating units derived from ethylene and repeating units derived from tetrafluoroethylene, a thermoplastic resin (B) (provided that the fluorinated copolymer (A) is excluded) and a medium (C) capable of dissolving at least the fluorinated copolymer (A), which comprises mixing the fluorinated copolymer (A) and the thermoplastic resin (B) in the medium (C) at a temperature of at least the dissolution temperature at which the fluorinated copolymer (A) dissolves in the medium (C) and not higher than the melting point of the fluorinated copolymer (A).

2. The method for producing a fluorinated copolymer composition according to claim 1, wherein as the medium (C), a solvent is used, of which the dissolution index (R) represented by the following formula (1) is less than 49:
R=4×(δd−15.7)²+(δp−5.7)²+(δh−4.3)² (1)
wherein δd, δp and δh represent the dispersion component, the polar component and the hydrogen bonding component [(MPa)^{1/2}], respectively, in Hansen solubility parameters of the solvent.

3. The method for producing a fluorinated copolymer composition according to claim 1, wherein in the fluorinated copolymer (A), the proportion of repeating units derived from monomers other than ethylene and tetrafluoroethylene, is from 0.1 to 50 mol %, based on all repeating units (100 mol %).

4. The method for producing a fluorinated copolymer composition according to claim 1, wherein as the medium (C), a solvent is used, with which a temperature range to exhibit a solution state with the fluorinated copolymer (A) is present at a temperature of not higher than 230° C.

5. The method for producing a fluorinated copolymer composition according to claim 1, wherein the mass ratio of the fluorinated copolymer (A) to the thermoplastic resin (B) (i.e. (A)/(B)) is from 99/1 to 1/99.

6. The method for producing a fluorinated copolymer composition according to claim 1, wherein the proportion of the medium (C) is from 10 to 99 mass % based on 100 mass % of the fluorinated copolymer composition.

7. The method for producing a fluorinated copolymer composition according to claim 1, wherein the medium (C) is diisopropyl ketone, 2-hexanone, cyclohexanone, 3′,5′-bis(trifluoromethyl)acetophenone, 2′,3′,4′,5′,6′-pentafluoroacetophenone, benzotrifluoride, or isobutyl acetate.

8. A coating composition comprising a fluorinated copolymer composition obtained by the method as defined in claim 1.

9. An article having a coating film formed by using the coating composition as defined in claim 8.

10. A molded product comprising the fluorinated copolymer (A) and the thermoplastic resin (B), obtained by using a fluorinated copolymer composition obtained by the method as defined in claim 1.
